(19) United States
(12) Patent Application Publication
(10) Pub. No.: US 2006/0061830 A1
(43) Pub. Date: Mar. 23, 2006

(54) Image reading apparatus

(75) Inventor: Jun Sakakibara, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/945,441

(22) Filed: Sep. 21, 2004

(51) Int. Cl. H04N 1/40

(52) U.S. Cl. 358/448; 358/474

(57) ABSTRACT

Presence of a streak image in a sub-scanning direction with respect to the image signal of the document image photoelectrically converted by a photoelectric conversion unit which converts an image of a document scanned in a sub-scanning direction into an image signal for each line of a main scanning direction is detected, and an image signal of a pixel forming the streak image is corrected in the image signal of the document image photoelectrically converted by the photoelectric conversion unit in a case where it is detected that the streak image has been generated in the image signal of the document image.

### BACKGROUND OF THE INVENTION

1. Field of the Invention

The present invention relates to an image reading apparatus which converts an image of a document into image data using a CCD sensor which is a photoelectric conversion unit.

2. Description of the Related Art

In recent years, in an image reading apparatus, a function (an image reading function) of reading an image of a sheet document conveyed by an auto document feeder has been regarded as important. In the image reading apparatus comprising the auto document feeder, the document is conveyed by the auto document feeder, and the image of the document being conveyed is read in a fixed document reading position. Therefore, when foreign matters such as rubbish and dust stick to a part of the document reading position, the foreign matters are constantly read in a specific position in a main scanning direction. In this case, a streaked image (image of the foreign matters) in a sub-scanning direction appears in the read image of the document regardless of an actual document image.

Moreover, in the image reading apparatus for reading the document image using a CCD sensor, a high-frequency distortion, low-frequency distortion, and distortion of light emitting characteristic in an image signal are corrected. The high-frequency distortion is caused by fluctuations of sensitivity of a photoelectric conversion sensor corresponding to pixels constituting the CCD sensor. The low-frequency distortion is caused by an optical system for guiding light from the document into the CCD sensor. The distortion of the light distributing characteristic is a distortion (light emitting unevenness) of light applied to the document from a light source in the document reading position. In the image reading apparatus, it is general to subject an output signal of the CCD sensor to shading correction in order to correct these distortions or unevenness. In this shading correction, the image signal is corrected using a black reference signal which is black reference and a white reference signal which is white reference. Especially, the white reference signal is acquired by reading of an image of a white reference member by the CCD sensor. Therefore, when foreign matters such as damage and dirt stick to a part of the white reference member, the image of the foreign matters is read as the white reference. In this case, the white reference signal has a value different from a desired value in the position corresponding to the foreign matters. As a result, a white streaked image appears in the read image of the document.

### BRIEF SUMMARY OF THE INVENTION

An object of the present invention is to reduce disadvantages of an image generated in a read image without lowering productivity.

According to the present invention, there is provided an image reading apparatus which converts a document image into image data, comprising: a photoelectric conversion unit which sequentially converts an image of a document scanned in a sub-scanning direction into an image signal constituted of a plurality of pixels constituting one line in a main scanning direction; a detection unit which detects presence of a streak image of the sub-scanning direction with respect to the image signal of the document image photoelectrically converted by the photoelectric conversion unit; and an image correction unit which corrects the image signal of the pixel forming the streak image detected by the detection unit among the image signals of the document image photoelectrically converted by the photoelectric conversion unit in a case where the detection unit detects that the streak image has been generated.

According to the present invention, there is provided an image reading apparatus which converts a document image into image data, comprising: a photoelectric conversion unit which sequentially converts an image of a document scanned in a sub-scanning direction into an image signal constituted of a plurality of pixels constituting one line in a main scanning direction; a detection unit which detects presence of a streak image of the sub-scanning direction with respect to the image signal of the document image photoelectrically converted by the photoelectric conversion unit; and an image correction unit which selectively executes a streak removing process to remove the pixels forming the streak image or a streak removing interpolation process to replace each pixel forming the streak image with a pixel linearly changing with respect to pixels before/after the streak image in a case where the detection unit detects that the streak image has been generated.

According to the present invention, there is provided an image reading apparatus which has a function of communicating with an external apparatus, comprising: a photoelectric conversion unit which sequentially converts an image of a document scanned in a sub-scanning direction into an image signal constituted of a plurality of pixels constituting one line in a main scanning direction; a detection unit which detects presence of a streak image of the sub-scanning direction with respect to the image signal of the document image photoelectrically converted by the photoelectric conversion unit; and a communication interface which notifies the external apparatus of generation of the streak image in a case where the detection unit detects that the streak image has been generated.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing a constitution of an image reading apparatus according to an embodiment of the present invention;

FIG. 2 is a block diagram showing a constitution example in a digital copying machine having the image reading apparatus, and a constitution example of a network system of the digital copying machine;

FIG. 3 is a diagram showing the image reading apparatus during reading of a white reference signal;

FIG. 4 is a diagram showing the image reading apparatus during the reading of an image of a document conveyed by an ADF;

FIG. 5 is a diagram showing the image reading apparatus after the reading of the document image;

FIG. 6 is a block diagram showing a constitution example in a signal processing unit;

FIG. 7 shows an example of a read image of a normal document which is not affected by foreign matters;

FIG. 8 shows an example of a read image in a case where the foreign matters stick to document glass of a document reading position;

FIG. 9 shows an example of an image obtained by removing a black streak image from the image of FIG. 8;

FIG. 10 shows an example of a read image in a case where foreign matters stick to a white reference plate;

FIG. 11 shows an example of an image obtained by removing a white streak image from the image of FIG. 10;

FIG. 12 shows an example of the read image in a case where foreign matters for three pixels stick to the document glass in the document reading position in a main scanning direction;

FIG. 13 shows an example of an image obtained by removing the black streak image from the image of FIG. 12;

FIG. 14 shows an example of the read image in a case where foreign matters for three pixels stick to the white reference plate in the main scanning direction;

FIG. 15 shows an example of the image obtained by removing the white streak image from the image of FIG. 14;

FIG. 16 shows an example of the read image in a case where the foreign matters stick to document glass 11 of a document reading position P1;

FIG. 17 shows an example of an image obtained by subjecting the image of FIG. 16 to a streak removing interpolation process;

FIG. 18 shows an example of the read image in a case where the foreign matters stick to the white reference plate;

FIG. 19 shows an example of an image obtained by removing the white streak image from the image of FIG. 18;

FIG. 20 shows an example of a read image in a case where the foreign matters stick to the document glass of the document reading position;

FIG. 21 shows an example of an image obtained by subjecting the image of FIG. 20 to the streak removing interpolation process;

FIG. 22 shows an example of a read image in a case where the foreign matters stick to the white reference plate;

FIG. 23 shows an example of an image obtained by subjecting the image of FIG. 22 to the streak removing interpolation process;

FIG. 24 is a flowchart showing an operation example in a case where the streak removing process or the streak removing interpolation process is executed in accordance with a type of the document image; and

FIG. 25 is a flowchart showing an operation example in a case where a foreign matter detection unit detects a streak image at the time of the reading of the document image.

### DETAILED DESCRIPTION OF THE INVENTION

An embodiment of the present invention will be described hereinafter with reference to the drawings.

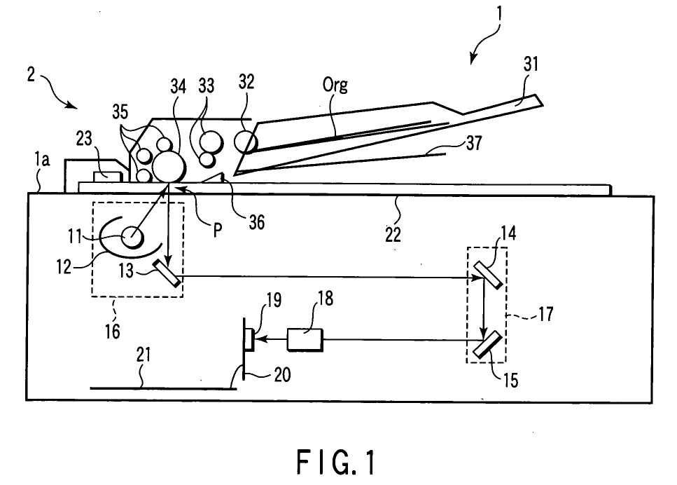

An image reading apparatus 1 according to an embodiment of the present invention is an apparatus which reads image information of a document by a pixel unit in accordance with resolution for each line. FIG. 1 is a sectional view showing a constitution of the image reading apparatus 1 according to the embodiment of the present invention. The image reading apparatus 1 shown in FIG. 1 comprises an image reading apparatus main body (image reading unit) 1a and an auto document feeder (ADF) 2.

First, a constitution of the image reading apparatus main body (image reading unit) 1a will be described.

As shown in FIG. 1, the image reading apparatus main body 1a comprises a light source 11, a reflector 12, a first mirror 13, a second mirror 14, a third mirror 15, a first carriage 16, a second carriage 17, a condenser lens 18, a CCD sensor 19, a CCD substrate 20, a scanner control substrate 21, a document base glass 22, a white reference plate 23 and the like.

The light source 11 emits light to be applied to a document Org. The reflector 12 uniformly applies the light emitted from the light source 11 with respect to the document Org. That is, the reflector 12 adjusts a light distributing characteristic in a reading position of the document Org. The first mirror 13 receives reflected light from the document Org. The first mirror 13 is disposed in such a manner as to guide the reflected light from the document Org into the second mirror 14.

The second mirror 14 receives the reflected light from the first mirror 13. The second mirror 14 is disposed in such a manner as to guide the reflected light from the first mirror 13 into the third mirror. The third mirror 15 receives the reflected light from the second mirror 14. The third mirror 15 is disposed in such a manner as to guide the reflected light from the second mirror 14 into the condenser lens 18. The condenser lens 18 condenses the reflected light from the third mirror. The condenser lens 18 is disposed in such a manner as to condense the reflected light from the third mirror 15 and form an image on an image forming surface of the CCD sensor 19.

The CCD sensor 19 is mounted on the CCD substrate 20. The CCD sensor 19 performs photoelectric conversion to convert light energy formed into the image by the condenser lens 18 into an electric charge. Accordingly, the CCD sensor 19 converts the image formed by the condenser lens 18 into an electric signal. The CCD substrate 20 outputs the electric signal photoelectrically converted by the CCD sensor 19 to the scanner control substrate 21.

The document base glass 22 is a document laying base on which the document Org is laid. The white reference plate 23 comprises a white member. The white reference plate 23 constitutes a white reference for correcting (shading correction) the read image of the document.

Moreover, the light source 11, reflector 12, and first mirror 13 are mounted on the first carriage 16. The second mirror 14 and third mirror 15 are mounted on the second carriage 17. The first carriage 16 is constituted in such a manner as to move in a left/right direction by driving means (not shown). The second carriage 17 is constituted in such a manner as to follow the same direction as that of the first carriage 16 at a ½ speed. Accordingly, even when the first carriage 16 moves, a light path length of the light guided to the image forming surface of the CCD sensor 19 from a document surface does not change.

That is, an optical system comprising the first mirror 13 mounted on the first carriage 16, the second mirror 14 mounted on the second carriage 17, and the third mirror 15 mounted on the second carriage is constituted in such a manner that the light path length from the document surface to the image forming surface of the CCD sensor 19 is usually constant.

For example, to read the image of the document laid on the document base glass 22, the first carriage 16 moves in a direction (sub-scanning direction) from left to right of FIG. 1. With movement of the first carriage 16 in the sub-scanning direction, a reading position (for one line of the main scanning direction) P with respect to the document Org moves from the left to the right (sub-scanning direction). When the reading position moves in the sub-scanning direction, the image (image for one line of the main scanning direction) of the reading position of the document Org is sequentially formed on the image forming surface of the CCD sensor 19. Accordingly, the CCD sensor 19 converts the image of the whole document into image information.

Moreover, a plurality of photodiodes is one-dimensionally arranged on the image forming surface of the CCD sensor 19. The CCD sensor 19 reads the image for one line of the main scanning direction by the plurality of one-dimensionally arranged photodiodes. For example, to read an A4 longitudinal direction by 297 mm with a resolution of 600 dots per inch (dpi), the CCD sensor 19 requires at least 297 mm/(25.4 mm/600 dpi)=7015.7 photodiodes. When the resolution is 600 dpi, the CCD sensor 19 generally comprises 7300 to 7600 photodiodes in consideration of a front/back margin.

However, efficiency of photoelectric conversion is not completely uniform in each photodiode constituting the CCD sensor 19 in some case. That is, the individual photodiodes constituting the CCD sensor 19 could output signals having different amplitudes even with an equal exposure amount. This phenomenon is referred to as high-frequency distortion.

Moreover, in the constitution shown in FIG. 1, low-frequency distortion sometimes occurs, and quantity of light drops in opposite ends of the reading position P as compared with a middle portion. The low-frequency distortion is generated by a fluctuation of the quantity of light emitted from the light source 11, characteristic of the reflector 12, and a drop of the quantity of light in the optical system from the document surface to the image forming surface of the CCD sensor 19. Especially, in the image reading apparatus constituted as shown in FIG. 1, an optical reduction system is used as an optical system. In the optical reduction system, the quantity of light drops more frequently in the opposite ends of the read image (image for one line of the main scanning direction) than in the middle portion by the condenser lens 18.

It is difficult to completely eliminate the above-described high-frequency and low-frequency distortions. Therefore, in the image reading apparatus, shading correction for correcting the high-frequency or low-frequency distortion is performed. In the shading correction, for example, an output signal of the CCD sensor 19 is corrected based on an image signal (black reference signal) which is a black reference and an image signal (white reference signal) which is a white reference.

For example, it is assumed that an effective bit number of the image signal output from the CCD sensor 19 is ten bits. In this case, in the shading correction, the output signal (each pixel) of each photodiode constituting CCD sensor 19 is normalized in such a manner that the black reference signal is “0” and the white reference signal is “1023”.

Moreover, it is assumed that the black reference signal is the output signal of each photodiode constituting the CCD sensor 19 in a state in which the light source 11 is turned off (in a state in which the light entering the CCD sensor 19 is eliminated). It is also assumed that the white reference signal is a signal output by each photodiode constituting the CCD sensor 19 in a state in which the white reference plate 23 is regarded as the reading position P and the light source 11 is turned on. That is, the white reference signal is the output signal of the CCD sensor 19 in a case where the light source 11 is turned on to read the image of the white reference plate 23. It is to be noted that the shading correction will be described later in detail.

Next, a constitution of the auto document feeder (ADF) 2 will be described.

The auto document feeder (ADF) 2 comprises a document tray 31, a pickup roller 32, a resist roller pair 33, a conveying drum 34, conveying rollers 35, a jump base 36, a document discharge unit 37 and the like.

The document tray 31 is a tray on which the document Org that is a reading object is laid. The pickup roller 32 picks up the documents Org stacked on the document tray 31 one by one, and supplies the document to the resist roller pair 33. The resist roller pair 33 conveys the document Org picked up by the pickup roller 32 toward the conveying drum 34. The resist roller pair 33 corrects tilt of the document Org, and prevents duplicate feeding of the document Org while conveying the document Org.

The conveying drum 34 and the conveying rollers 35 convey the document Org conveyed from the resist roller pair 33. The conveying drum 34 presses the reading surface of the document Org onto the surface of the original base glass in the reading position P to convey the document. The jump base 36 is a member which guides the document Org conveyed by the conveying drum 34 and conveying rollers 35 to the document discharge unit 37. The document discharge unit 37 stacks the documents Org to be discharged.

Next, a constitution example of a digital copying machine 41 comprising the above-described image reading apparatus, and a system including the digital copying machine 41.

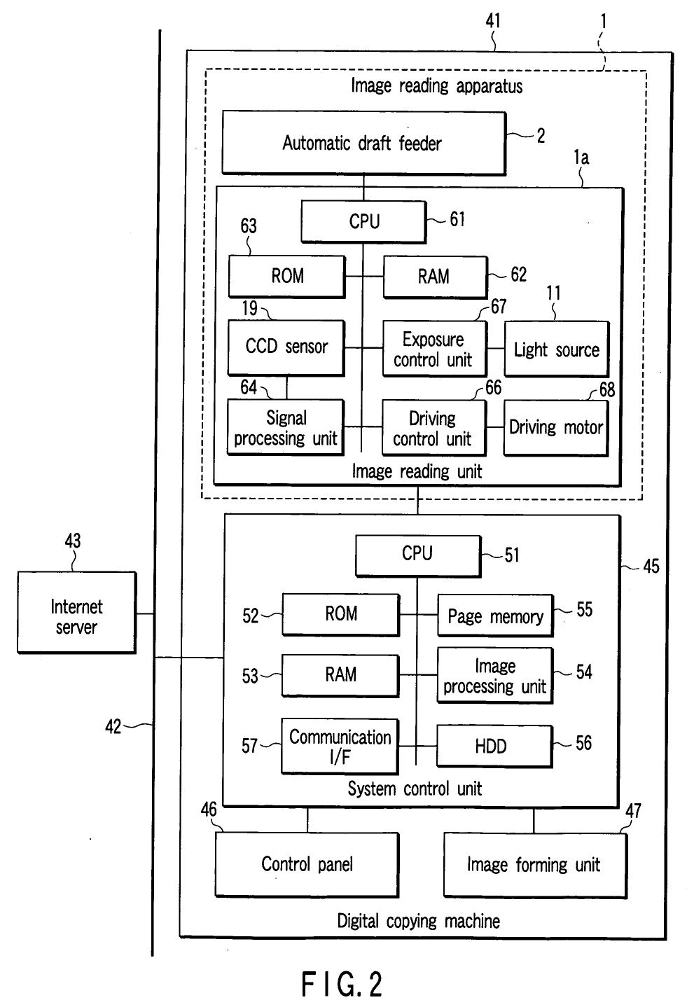

FIG. 2 is a block diagram showing a constitution example of a control system in the image reading apparatus main body (image reading unit) 1a, a constitution example in the digital copying machine 41, and a constitution example of a network system including the digital copying machine 41.

As shown in FIG. 2, the digital copying machine 41 is connected to an internet server 43 via a network 42. The digital copying machine 41 comprises a system control unit 45, a control panel 46, an image forming unit 47, the image reading unit 1a, and the auto document feeder 2.

The digital copying machine 41 is connected to the network 42. The network 42 is, for example, a local area network. The internet server 43 is a server device for correcting an apparatus connected to the network 42 to another network such as internet. The internet server 43 is operated, for example, in a center (not shown) which performs maintenance of the digital copying machine 41 or provides services relating to the digital copying machine 41.

For example, when a disadvantage is generated in the digital copying machine 41, the internet server 43 is notified that the disadvantage is generated from the digital copying machine 41. When the internet server 43 is notified of the disadvantage, a person who has technical knowledge of maintenance and the like (herein referred to as a serviceman) is dispatched in a center that provides the services with respect to the digital copying machine 41. Accordingly, the serviceman realizes a service system in such a manner as to perform the maintenance of the digital copying machine 41.

The system control unit 45 executes a control of the whole digital copying machine 41. The system control unit 45 has a CPU 51, a ROM 52, a RAM 53, an image processing unit 54, a page memory 55, a hard disk drive (HDD) 56, a communication interface (I/F) 57 and the like.

The CPU 51 executes a control of the whole system control unit 45. The ROM 52 is a nonvolatile memory. In the ROM 52, for example, a control program or control data is stored. The RAM 53 comprises a volatile memory. In the RAM 53, for example, various parameters, data for operation and the like are stored. The image processing unit 54 processes the image with respect to the image data. The communication interface 57 is an interface which performs data communication with an external apparatus via the network 42.

The control panel 46 is a user interface in which various operation instructions are input. The control panel 46 comprises, for example, a liquid crystal display device containing a touch panel, hard keys such as ten keys and the like. The image forming unit 47 is a printer which forms an image on an image forming medium in accordance with the image data supplied from the system control unit 45.

Next, an operation of the digital copying machine constituted as described above will be schematically described.

First, it is assumed that the user inputs an instruction for copying in the control panel 46. On receiving the copying instruction from the control panel 46, the CPU 51 of the system control unit 45 outputs an instruction for reading the document image to the image reading apparatus 1. In the image reading apparatus 1, a process of reading the document image is performed in response to the instruction for reading the document image from the system control unit 45. The image data of the document read by the process of reading the document image is supplied to the system control unit 45 from the image reading apparatus 1.

In the system control unit 45, the image processing unit 54 converts a format of the image data supplied from the image reading apparatus 1 into a format (format for forming the image) for the image forming unit 47 to perform an image forming process. When the format of the image data of the document read by the image reading apparatus 1 is converted into the format for forming the image, the system control unit 45 outputs the image data to the image forming unit 47 at a predetermined timing. In the image forming unit 47, the image is formed on the image forming medium in accordance with the image data supplied from the system control unit 45. For example, an image is formed on a sheet by an electrophotographic system in the image forming unit 47.

Moreover, it is assumed that the user inputs instructions to scan the document image and transfer the image data of the document in the control panel 46. In this case, the CPU 51 of the system control unit 45 outputs an instruction to read the document image to the image reading apparatus 1. In the image reading apparatus 1, the process of reading the document image is performed in accordance with an instruction to read the document image from the system control unit 45. The image data of the document read by the process of reading the document image is supplied to the system control unit 45 from the image reading apparatus 1.

In the CPU 51 of the system control unit 45, the image reading apparatus 1 receives the read image data, and temporarily stores the data in HDD or the like. In this case, in the CPU 51, the image processing unit 54 converts the image data into a desired format. When the image reading apparatus 1 stores the read image data in the HDD, the CPU 51 transfers the image data to a desired client PC (not shown) via the network 42 by the communication interface 57.

Moreover, the digital copying machine 41 has a function (network printer function) of printing the image data from the client PC (not shown) connected to the network 42. For example, it is assumed that the system control unit 45 receives a signal for printing output (printing request and image data for the printing output) from the client PC (not shown) connected to the network 42 by the communication interface 57. In this case, in the system control unit 45, the image data for the printing output received from the client PC is temporarily stored in the HDD or the like. In this case, the system control unit 45 converts the format of the received image data into the format (format for image forming) for the image forming unit 47 to perform the image forming process. Furthermore, the system control unit 45 outputs the image data converted into the format for the image forming to the image forming unit 47 at a predetermined timing. The image forming unit 47 forms the image on the image forming medium in accordance with the image data supplied from the system control unit 45.

Moreover, the system control unit 45 also has a function of performing the data communication with the external apparatus via the network 42 and the internet which is an external network. For example, the system control unit 45 has a function of transmitting the image data to the external apparatus via the network 42 and the internet. The system control unit 45 also has a function of transmitting information indicating the present state of the digital copying machine 41 to the external apparatus on the internet.

Next, a constitution of the control system of the image reading unit 1a will be described.

The control system of the image reading apparatus is disposed, for example, on the control substrate 21 of the image reading apparatus main body (image reading unit) 1a. As shown in FIG. 2, a CPU 61, a RAM 62, a ROM 63, a signal processing unit 64, a driving control unit 66, an exposure control unit 67 and the like are disposed on the control substrate 21 of the image reading unit 1a.

The CPU 61 executes a control of the whole image reading unit 1a. The RAM 62 comprises a volatile memory or the like. The ROM 63 comprises a nonvolatile memory. In the ROM 63, a control program executed by the CPU 61, control data and the like are stored. For example, in the ROM 63, coordinate values are stored indicating the position of the first carriage 16 corresponding to the reading position of the black reference, the white reference, or the document conveyed by the ADF 2.

The signal processing unit 64 processes the output signal (image data) from the CCD sensor 19. The signal processing unit 64 performs processes such as an analog/digital conversion process, shading correction process, and image correction process. The constitution in the signal processing unit 64 will be described later in detail. The driving control unit 66 performs a driving control of a driving motor 68 which drives the first carriage 16 in the image reading apparatus main body 1a. The exposure control unit 67 performs a lighting control of the light source 11.

Next, an operation for reading the document image using the auto document feeder 2 will be described.

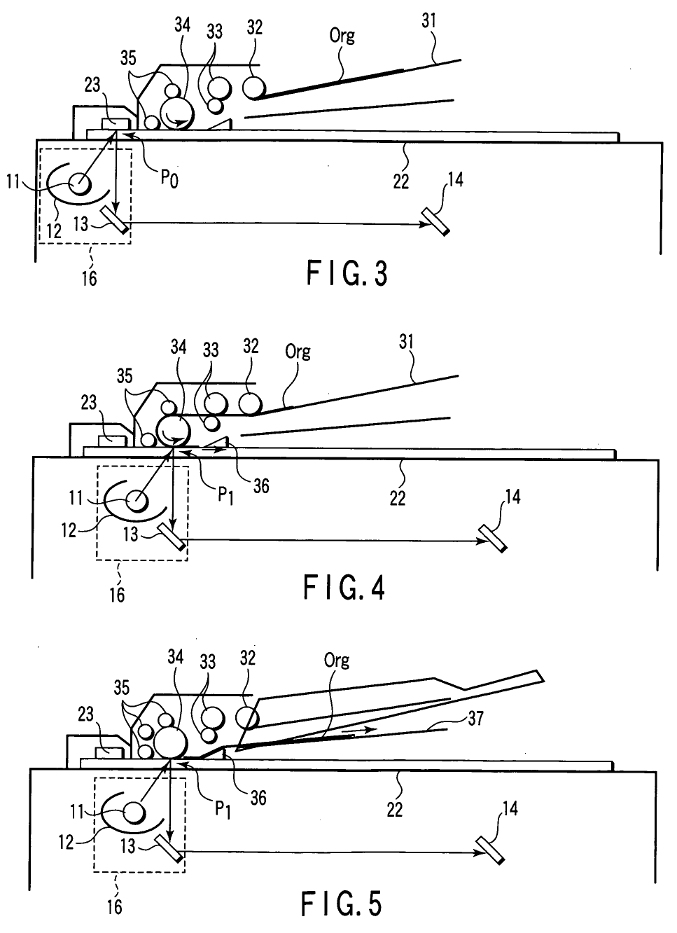

FIG. 3 is a diagram showing the image reading apparatus during the reading of the white reference signal. FIG. 4 is a diagram showing the image reading apparatus during the reading of the image of the document conveyed by the ADF 2. FIG. 5 is a diagram showing the image reading apparatus after the reading of the document image.

First, to perform the process of reading the document image using the ADF 2, the image reading apparatus performs processes of reading the black reference signal, white reference signal, and document image in order. In the process of reading the black reference signal (black reference reading process), the light source 11 is turned off, and the image is read as the black reference. In the process of reading the white reference signal, the light source 11 is turned on to read the image of the white reference plate 23. In the process of reading the document image, the document image conveyed by the ADF 2 is read in a predetermined reading position P1.

That is, the CPU 61 performs processes of reading the black reference signal (black reference reading process), white reference signal (white reference reading process), and document image (document reading process) in order.

First, in the process of reading the black reference signal, the CPU 61 brings the light source 11 into an extinguished state by the exposure control unit 67, drives the driving motor 68 by the driving control unit 66, and moves the first carriage 16 to the left end shown in FIG. 1 (the left side of the white reference plate 23).

When the first carriage 16 is moved to the left end, the CPU 61 keeps the light source 11 in the extinguished state while moving the first carriage 16 to the right side (sub-scanning direction) from the left end of FIG. 1 by several lines by the driving control unit 66. During the movement, the CCD sensor 19 outputs a signal as the black reference. That is, the CCD sensor 19 reads the image for several lines as a black reference image in a state in which the light source 11 is extinguished. In the signal processing unit 64, an average value for each pixel in an output signal (black reference image) for several lines from the CCD sensor 19 is obtained as the black reference signal.

Next, the CPU 61 performs the process of reading the white reference signal. In the white reference reading signal, the CPU 61 brings the light source 11 into a lit state by the exposure control unit 67, drives the driving motor 68 by the driving control unit 66, and moves the first carriage 16 to a reading start position of the white reference. A reading position P0 shown in FIG. 3 shows the reading position of the first carriage 16 with respect to the white reference plate 23.

When the first carriage 16 is moved to the reading start position of the white reference, the CPU 61 keeps the light source 11 in the lit state while moving the first carriage 16 to the right side (sub-scanning direction) by several lines by the driving control unit 66. During the movement, the CCD sensor 19 outputs a signal as the white reference. That is, the CCD sensor 19 reads the image for several lines of the white reference plate 23 read in a state in which the light source 11 is lit as a white reference image. In the signal processing unit 64, an average value for each pixel in an output signal (white reference image) for several lines from the CCD sensor 19 is obtained as the white reference signal.

Next, the CPU 61 performs the process of reading the document image. In the document reading signal, the CPU 61 keeps the light source 11 in the lit state by the exposure control unit 67, drives the driving motor 68 by the driving control unit 66, and moves the first carriage 16 to the reading position P1 of the document. The reading position P1 shown in FIGS. 4 and 5 indicates the reading position with respect to the document conveyed by the ADF 2.

On the other hand, the CPU 61 instructs the ADF 2 to start conveying the document. The ADF 2 starts conveying the document Org on the document tray 31 in response to the instruction from the CPU 61. The document Org on the document tray 31 is picked up sheet by sheet by the pickup roller 32. A tip of the document Org picked up by the pickup roller 32 is conveyed to the resist roller pair 33. A sensor (not shown) for detecting that the document has arrived before the resist roller pair 33 is disposed before the resist roller pair 33.

The document Org detected before the resist roller pair 33 by the sensor is conveyed to a subsequent stage by the resist roller pair 33 in response to a timing indicated by the CPU 61. In the subsequent stage of the resist roller pair 33, the document Org is conveyed by the conveying drum 34 and the conveying rollers 35. As shown in FIG. 4, the document Org conveyed by the conveying drum 34 and the conveying rollers 35 passes through the reading position P1 of the document, and is conveyed to the document discharge unit 37. As shown in FIG. 5, the document Org passed through the document reading position P1 is guided to the document discharge unit 37 by the jump base 36.

Moreover, as shown in FIG. 4, in the document reading position P1, light from the light source 11 is applied to the document through the document base glass 22, and the reflected light strikes on the first mirror 13. The light which has struck on the first mirror 13 (reflected light from the document) is applied to the CCD sensor 19 via the optical system including the second mirror, third mirror, condenser lens and the like. That is, as to the document Org conveyed by the ADF 2, the image of the main scanning direction is sequentially read in the document reading position P1. The image information (output signal from the CCD sensor 19) photoelectrically converted in the CCD sensor 19 is corrected using the black and white reference signals by the signal processing unit 64.

Next, the signal processing unit 64 will be described.

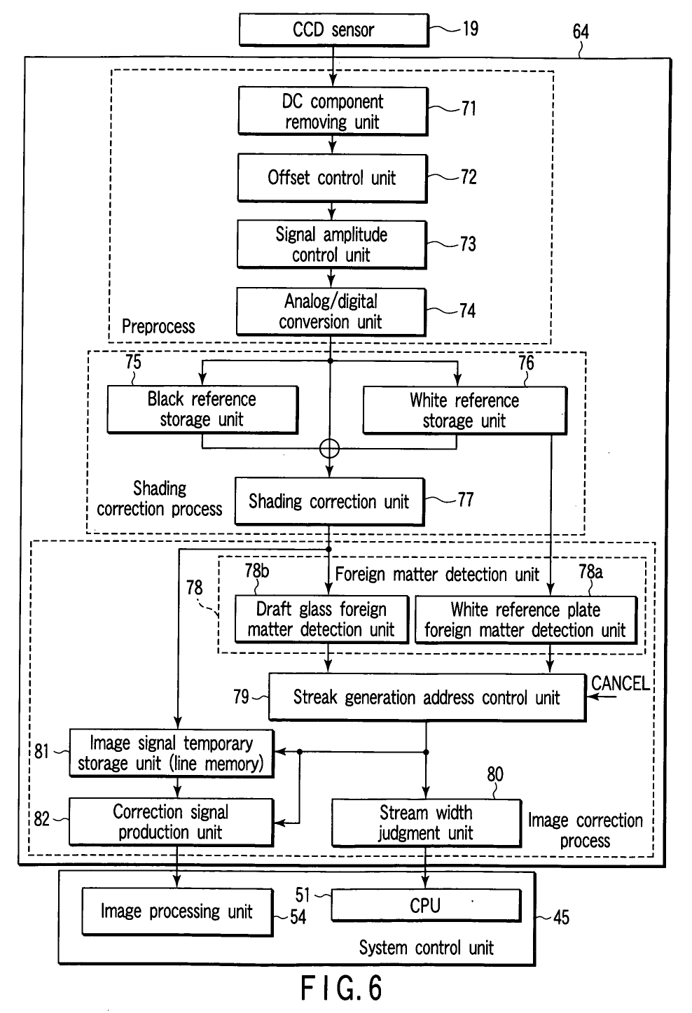

FIG. 6 is a block diagram showing a constitution example in the signal processing unit 64.

As shown in FIG. 6, the signal processing unit 64 performs a preprocess, a shading correction process, and an image correction process. The preprocess is a process with respect to the output signal from the CCD sensor 19. The shading correction process is a correction process with respect to the output signal of the CCD sensor 19 using the black and white reference signals. The image correction process is a correction process with respect to the image data which is an output signal of the CCD sensor 19.

First, the preprocess in the signal processing unit 64 will be described.

The preprocess in the signal processing unit 64 is performed by a DC component removing unit 71, an offset control unit 72, a signal amplitude control unit 73, and an analog/digital conversion unit 74.

First, the output signal from the CCD sensor 19 includes a direct-current component which is a direct-current output voltage. Therefore, the DC component removing unit 71 removes the direct-current component included in the output signal from the CCD sensor 19. The DC component removing unit 71 comprises, for example, a capacitor inserted in series to the output signal of the CCD sensor 19.

Furthermore, the output signal of the CCD sensor 19 includes an induction noise, and a reset noise by a reset signal input into the CCD sensor 19. That is, the output signal of the CCD sensor 19 is not a signal having a constant level. Therefore, the offset control unit 72 and the signal amplitude control unit 73 perform an offset control, and adjust amplitude with respect to the output signal of the CCD sensor 19.

The offset control unit 72 performs the offset control with respect to the output signal of the CCD sensor 19. The offset control unit 72 controls the output signal of the CCD sensor 19 in such a manner that a potential of an empty portion that is not an effective pixel of the CCD sensor 19 indicates a desired voltage.

The signal amplitude control unit 73 adjusts the amplitude of the output signal of the CCD sensor 19. The signal amplitude control unit 73 adjusts the amplitude of an offset-controlled signal in such a manner as to match the amplitude with an input range of the analog/digital conversion unit 74.

The analog/digital conversion unit 74 converts an analog signal into a digital signal. In the analog/digital conversion unit 74, the analog signal whose amplitude has been adjusted in the signal amplitude control unit 73 is converted into the digital signal.

By the preprocess in the analog/digital conversion unit 74, the output signal of the CCD sensor 19 is converted into the digital signal from the analog signal. Therefore, in the signal processing unit 64, the output signal (image signal) of the CCD sensor 19 is processed as the digital signal in the process of and after the analog/digital conversion unit 74.

Next, the shading correction process in the signal processing unit 64 will be described.

The shading correction process in the signal processing unit 64 is performed by a black reference storage unit 75, a white reference storage unit 76, and a shading correction unit 77. The black reference storage unit 75 stores the black reference signal with respect to the output signal (image signal) of the CCD sensor 19. The black reference storage unit 75 comprises a memory to store the black reference signal for each pixel and the like. The white reference storage unit 76 stores the white reference signal with respect to the output signal (image signal) of the CCD sensor 19. The white reference storage unit 76 comprises a memory to store the white reference signal for each pixel and the like. The shading correction unit 77 corrects a read image (image signal) of the document using the black and white reference signals.

Next, an operation of the shading correction process in the signal processing unit 64 will be described.

As described above, in the present image reading apparatus 1, the black reference reading process, the white reference reading process, and the document reading process are performed in order. In the shading correction process, the image signal (output signal of the CCD sensor 19) read by the document reading process is corrected using the black reference signal obtained by the black reference reading process, and the white reference signal obtained by the white reference reading process.

First, in the black reference reading process, the black reference image for a plurality of lines is read in a state in which the light source 11 is extinguished, that is, any light is not applied to the CCD sensor 19. In this case, in the signal processing unit 64, the output signal of the CCD sensor 19 is preprocessed, and the image signal is stored as a black reference signal Dbk in the black reference storage unit 75. The image signal which is the black reference signal Dbk is averaged for each pixel, and stored in the black reference storage unit 75.

Next, in the white reference reading process, the image (white reference image) of the white reference plate 23 is read in the lit state of the light source 11. In this case, in the signal processing unit 64, the output signal of the CCD sensor 19 is preprocessed, and the image signal is stored as a white reference signal Dwt in the white reference storage unit 76. The image signal which is the white reference signal Dwt is averaged for each pixel, and stored in the white reference storage unit 76.

Next, in the document image reading process, the first carriage 16 is moved to the reading position of the document image to perform the reading process of the document image. Here, the reading of the document image using the auto document feeder 2 as shown in FIGS. 4 and 5 will be described.

That is, after reading the image of the white reference plate 23, the first carriage 16 moves to the right side, and stops in a predetermined document reading position P1 as shown in FIG. 4. On the other hand, the auto document feeder 2 conveys the document Org in accordance with a timing when the first carriage 16 moves to the document reading position. Accordingly, the image of the document Org conveyed by the auto document feeder 2 is sequentially read for each line of the main scanning direction in the document reading position P1. That is, the CCD sensor 19 sequentially outputs an image signal Dim for each line of the main scanning direction to the signal processing unit 64.

As to the image signal Dim sequentially supplied from the CCD sensor 19, the signal processing unit 64 preprocesses the output signal (image signal Dim) supplied from the CCD sensor 19, and subjects the image signal Dim to the shading correction. The shading correction is executed by the shading correction unit 77 using the black reference signal Dbk stored in the black reference storage unit 75 and the white reference signal Dwt stored in the white reference storage unit 76.

For example, when an effective bit number of the image signal is ten bits, the shading correction unit 77 calculates an image signal Dout after the shading correction in the following calculation equation.
Dout=(Din−Dbk)/(Dwt−Dbk)×1023

It is to be noted that when the effective bit number of the image signal (signal after the shading correction) is set to eight bits, constant “1023” of the above calculation equation is replaced with “255”.

Next, an image correction process in the signal processing unit 64 will be described.

The image correction process in the signal processing unit 64 is executed by a foreign matter detection unit 78, a streak generation address control unit 79, a streak width judgment unit 80, an image signal temporary storage unit (line memory) 81, a correction signal generation unit 82 and the like. By this constitution, the signal processing unit 64 realizes a function of performing various image correction processes with respect to the image signal subjected to the shading correction.

The foreign matter detection unit 78 detects foreign matters such as dirt and rubbish sticking to the white reference plate 23 or the document glass 11. The foreign matter detection unit 78 detects the streak image of the sub-scanning direction in the image signal subjected to the shading correction to thereby the foreign matters sticking to the white reference plate 23 or the document glass 11. The foreign matter detection unit 78 has a white reference plate foreign matter detection unit 78a and a document glass foreign matter detection unit 78b.

The white reference plate foreign matter detection unit 78a detects foreign matters such as dirt and rubbish sticking to the white reference plate 23. The white reference plate foreign matter detection unit 78a detects a white streak image of the sub-scanning direction in the image signal subjected to the shading correction to thereby detect the foreign matters sticking to the white reference plate 23. The document glass foreign matter detection unit 78b detects foreign matters such as dirt and rubbish sticking to the document glass 11. The document glass foreign matter detection unit 78b detects a black streak image of the sub-scanning direction in the image signal subjected to the shading correction to thereby detect the foreign matters sticking to the document glass 11.

The streak generation address control unit 79 and the streak width judgment unit 80 indicate a position and a width of the streak image detected by the foreign matter detection unit 78.

The streak generation address control unit 79 indicates the position (address) in which the streak image of the sub-scanning direction detected by the foreign matter detection unit 78 is generated. In the streak generation address control unit 79, a generation address of the streak image of the sub-scanning direction detected by the foreign matter detection unit 78 in the main scanning direction is set. The streak generation address control unit 79 has a function of controlling the address of the image signal to be stored in the image signal temporary storage unit 81.

The streak width judgment unit 80 indicates the width of the white streak image or the black streak image generated by the foreign matters sticking to the white reference plate 23 or the document glass 11. In the streak width judgment unit 80, data indicating the width of the streak image of the sub-scanning direction detected by the foreign matter detection unit 78 in the main scanning direction is set. For example, in the streak width judgment unit 80, the number of pixels in the main scanning direction of the streak image is set as data indicating the width of the streak image.

The image signal temporary storage unit 81 stores the image signal processed by the shading correction unit 77. The image signal temporary storage unit 81 comprises a memory to sequentially store the image signal for each pixel and the like. The image signal temporary storage unit 81 refers to the streak generation address control unit 79 while sequentially adding up memory addresses, and sequentially reads the image signal corresponding to each address.

The correction signal generation unit 82 corrects the image signal stored in the image signal temporary storage unit 81. The correction signal generation unit 82 corrects the only image signal of a specific address. Therefore, the correction signal generation unit 82 passes an image signal which does not require any correction, and outputs the signal to the image processing unit 54 in the subsequent stage.

Next, the foreign matter detection unit 78 will be described in detail.

First, the detection of the foreign matters sticking to the white reference plate 23 by the white reference plate foreign matter detection unit 78a will be described.

As described above, when foreign matters such as dirt and damage stick to a part of the white reference plate 23, the foreign matters affect the white reference signal. Therefore, when the foreign matters stick to a part of the white reference plate 23, a white streaked image (white streak image) sometimes appears in the read image of the document regardless of an actual document image.

In the shading correction, the image signal (color information) read from the white reference plate 23 largely affects the image signal Dout after the shading correction. Therefore, in the white reference reading process, the first carriage 16 is moved while the image of the white reference plate 23 is read for a plurality of lines, and the average value of the image signals for the plurality of lines is obtained as the white reference signal Dwt. However, when streaked foreign matters of the sub-scanning direction stick to the white reference plate 23, and even when the image signals for the plurality of lines are averaged, images of the foreign matters sticking to the white reference plate 23 appear as peculiar points in the white reference signal.

The signal processing unit 64 detects the above-described foreign matters sticking to the white reference plate 23 by the white reference plate foreign matter detection unit 78a. The white reference plate foreign matter detection unit 78a detects the above-described peculiar points in the read image of the white reference plate 23 to thereby detect whether or not the foreign matters stick to the white reference plate 23. That is, the above-described peculiar point is an image signal having a value different from that of another pixel, and constantly appears in the same position in the main scanning direction. Therefore, the white reference plate foreign matter detection unit 78a detects the presence of the peculiar point and the position (address of the main scanning direction) of the peculiar point depending on whether or not there is obviously a pixel having a value different from a value (white reference value) of the other pixel in the same position in the main scanning direction.

Next, the detection of the foreign matters sticking to the document glass 11 by the document glass foreign matter detection unit 78b will be described.

To read the document image using the auto document feeder 2, the reading position of the document image is fixed to a predetermined document reading position P1. The image of the document conveyed by the auto document feeder 2 is read in the document reading position P1 via the document glass 11. Therefore, when foreign matters such as dirt and damage stick to a part of the document glass 11, images of foreign matters constantly appear as peculiar points of an image signal having an equal value in the same position in the main scanning direction.

The signal processing unit 64 detects the above-described foreign matters sticking to the document glass 11 by the document glass foreign matter detection unit 78b. The document glass foreign matter detection unit 78b detects the above-described peculiar points in the read image of the document to thereby detect whether or not the foreign matters stick to the document reading position P1 of the document glass 11. For example, the above-described peculiar point appears as an image signal having an equal value in the same position in the main scanning direction. Therefore, the document glass foreign matter detection unit 78b detects the presence of the peculiar point and the position (address of the main scanning direction) of the peculiar point depending on whether or not there is constantly a pixel having the equal value in the same direction in the main scanning direction in the read image of the whole document.

Next, a first image correction process in the signal processing unit 64 will be described.

In this first image correction process, when the foreign matters exist on the document glass 11 and the white reference plate 23, the image signals of the foreign matters are removed. It is to be noted that the foreign matters on the document glass 11 or the white reference plate 23 appear as images of black streaks (black streak images) or images of white streaks (white streak images) in the read image of the document image. In the present embodiment, the first image correction process is referred to as a streak removing process.

A concrete operation example of the streak removing process will be described hereinafter.

First, an operation example will be described in a case where the black streak image having a width for one pixel is removed.

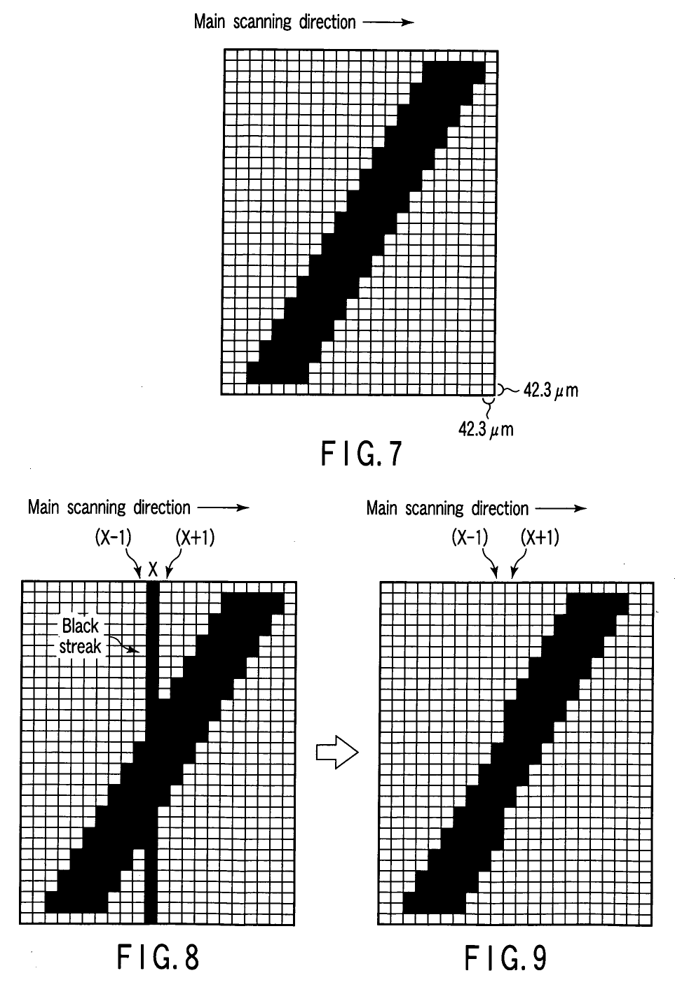

FIG. 7 shows an example of a read image of a normal document which is not affected by foreign matters. FIG. 8 shows an example of a read image in a case where the foreign matters stick to the document glass 11 of the document reading position P1. FIG. 9 shows an example of an image obtained by removing the black streak image from the image of FIG. 8. In FIGS. 7, 8, and 9, a lateral direction corresponds to the main scanning direction, and a longitudinal direction corresponds to the sub-scanning direction.

It is to be noted that in the following description, it is assumed that the image has a resolution of 600 dpi, and one pixel (each shown block) has a size of 42.3 μm×42.3 μm. The streak removing process is not limited to the case where the resolution of the image is 600 dpi, and is similarly applicable to images having various resolutions.

Here, it is assumed that the address of the black streak image in the main scanning direction is X in the image shown in FIG. 8. With respect to the image shown in FIG. 8, the document glass foreign matter detection unit 78b detects that the black streak image by the foreign matter sticking to the document glass 11 exists in the address X. That is, the document glass foreign matter detection unit 78b judges that the address of the black streak image is “X”, and the width of the black streak image is “1” (for one pixel). In this case, in the streak generation address control unit 79, address=X is set as a generation address of the black streak image. In the streak width judgment unit 80, “1” indicating that the width of the black streak image corresponds to one pixel is set.

In this case, the image signal temporary storage unit 81 does not read the image signal (i.e., image signal of the address X) for “1” pixel set in the streak width judgment unit 80 from the address=X set in the streak generation address control unit 79 in the image signal Dout normalized by the shading correction unit 77. That is, when the address=X is set in the streak generation address control unit 79, and “1” is set in the streak width judgment unit 80, the image signal temporary storage unit 81 reads the image signal in order of address (X−2), (X−1), (X+1), (X+2), Accordingly, the image signal from which the pixel of the address X has been removed is stored in the image signal temporary storage unit 81. As a result, as shown in FIG. 9, the image signal (black streak image) of the address X in the main scanning direction is removed in the whole read image.

Next, an operation example will be described in a case where the white streak image having a width for one pixel is removed.

When streaked foreign matters stick to the white reference plate 23, the white streak image appears in a position in which the foreign matters stick in the read image of the document. Also in this case, it is possible to remove the white streak image by a streak removing process which is similar to the above-described streak removing process of the black streak image.

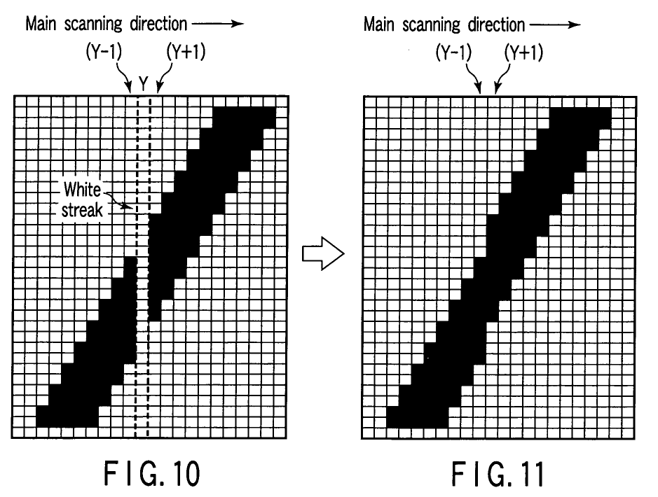

FIG. 10 shows an example of a read image in a case where the foreign matters stick to the white reference plate 23. FIG. 11 shows an example of an image obtained by removing a white streak image from the image of FIG. 10. In FIGS. 10 and 11, the lateral direction corresponds to the main scanning direction, and the longitudinal direction corresponds to the sub-scanning direction.

Here, it is assumed that the address of the white streak image in the main scanning direction is Y in the image shown in FIG. 10. In this case, the white reference plate foreign matter detection unit 78a detects that the white streak image by the foreign matter sticking to the white reference plate 23 exists in the address Y. Accordingly, in the streak generation address control unit 79, the address=Y is set as the generation address of the white streak image. Moreover, “1” indicating that the width of the white streak image corresponds to one pixel is stored in the streak width judgment unit 80.

The image signal temporary storage unit 81 reads the image signal in order of addresses (Y−2), (Y−1), (Y+1), (Y+2), . . . in such a manner that the image signal (i.e., image signal of the address Y) for “1” pixel set in the streak width judgment unit 80 is not read from the address=Y set in the streak generation address control unit 79. Accordingly, the image signal from which the pixel of the address Y has been removed is stored in the image signal temporary storage unit 81. As a result, as shown in FIG. 11, the image signal (white streak image) of the address Y in the main scanning direction is removed in the whole read image.

According to the above-described streak removing process, since the streak images for one pixel are removed, image information for one pixel lacks in the whole read image. This means that the read image is deteriorated. However, when the above-described streak removing process is not performed, the streak image appears in the read image. That is, when the streak removing process is performed with respect to the streak image for one pixel, the image reading apparatus can provide an image without any sense of incongruity for the user without decreasing the productivity.

For example, as shown in FIG. 9 or 11, when the image for one pixel is removed, image information having a width of 42.3 μm is lost in the main scanning direction in the whole read image. In general, a human visual characteristic corresponds to a resolution of about 300 dpi. Considering this, even when the image information having a width of 42.3 μm is removed from the read image, the user hardly senses the deterioration of the image. On the other hand, the black streak image on a white base or the white streak image on a black base is easily recognized by persons, even when the image has a width of 42.3 μm.

That is, when the black or white streak image exists in the read image of the document, and even when the image corresponds to one pixel, the user has a sense of incongruity with respect to the read image in many cases. On the other hand, in the above-described streak removing process, the black or white streak image is removed, and accordingly the read image can be provided without giving any sense of incongruity to the user.

Especially, in images in which gradation changes are not regarded as important, such as character and map images, the streak image is preferably removed by the streak removing process. This is because the image is obtained without any sense of incongruity in the character or map image, even when the image for one pixel lacks.

Next, an operation example will be described in which the black streak image having a width for a plurality of pixels is removed.

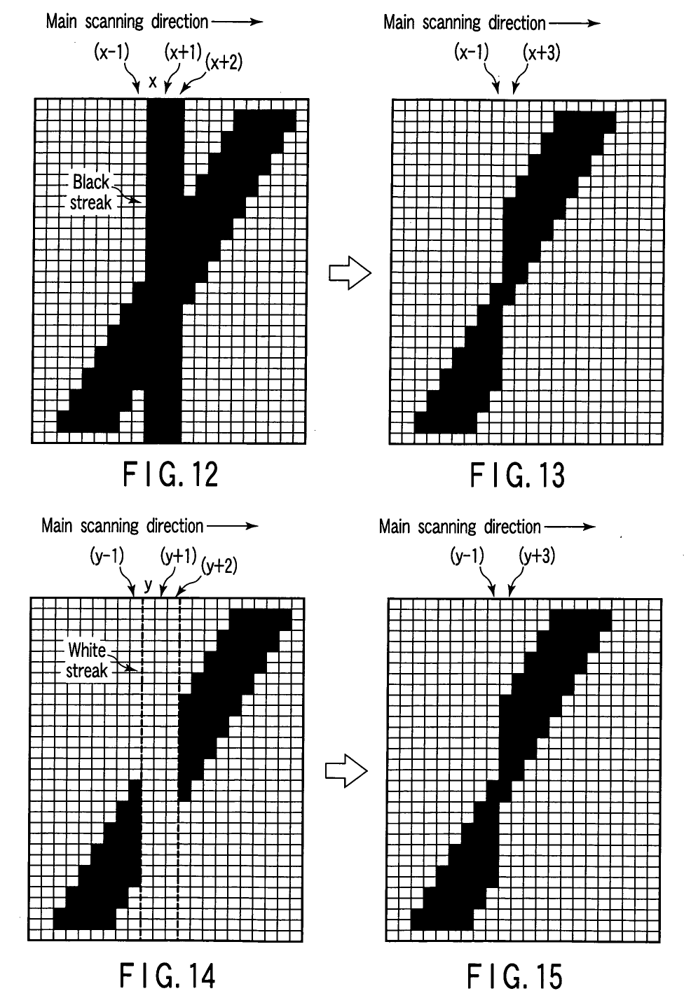

FIG. 12 shows an example of the read image in a case where foreign matters for three pixels stick to the document glass 11 in the document reading position P1 in the main scanning direction. FIG. 13 shows an example of an image obtained by removing the black streak image from the image of FIG. 12. In FIGS. 12 and 13, the lateral direction corresponds to the main scanning direction, and the longitudinal direction corresponds to the sub-scanning direction.

Here, it is assumed that the addresses of the black streak images in the main scanning direction are X, X+1, X+2 in the image shown in FIG. 12. The document glass foreign matter detection unit 78b detects that the black streak images by the foreign matters sticking to the document glass 11 exist in the addresses X, X+1, X+2 with respect to the image shown in FIG. 12. That is, the document glass foreign matter detection unit 78b judges that the addresses of the streak images are “X, X+1, X+2”, and the width of the black streak image is “3” (for three pixels). In this case, the address=X is set as the generation address of the black streak image in the streak generation address control unit 79. In the streak width judgment unit 80, “3” indicating that the width of the black streak image corresponds to three pixels is set.

In this case, the image signal temporary storage unit 81 does not read the image signals (i.e., the image signals of the addresses X, X+1, X+2) for “3” pixels set in the streak width judgment unit 80 from the address=X set in the streak generation address control unit 79 in the image signal Dout normalized by the shading correction unit 77. That is, when the address=X is set to the streak generation address control unit 79, and “3” is set in the streak width judgment unit 80, the image signal temporary storage unit 81 reads the image signals in order of addresses (X−2), (X−1), (X+3), (X+4), . . . Accordingly, the image signals from which the signals for three pixels in the addresses X, X+1, X+2 have been removed are stored in the image signal temporary storage unit 81. As a result, as shown in FIG. 13, the image signals (black streak images) of the addresses X, X+1, X+2 in the main scanning direction are removed in the whole read image.

Next, an operation example will be described in a case where the white streak image having a width corresponding to a plurality of pixels.

FIG. 14 shows an example of the read image in a case where the foreign matters for three pixels stick to the white reference plate 23 in the main scanning direction. FIG. 15 shows an example of the image obtained by removing the white streak image from the image of FIG. 14. In FIGS. 14 and 15, the lateral direction corresponds to the main scanning direction, and the longitudinal direction corresponds to the sub-scanning direction.

Here, it is assumed that the addresses of the white streak images in the main scanning direction are Y, Y+1, Y+2 in the image shown in FIG. 14. The white reference plate foreign matter detection unit 78a detects that the white streak images by the foreign matters sticking to the white reference plate 23 exist in the addresses Y, Y+1, Y+2 with respect to the image shown in FIG. 14. In this case, the address=Y is set as the generation address of the white streak image in the streak generation address control unit 79. In the streak width judgment unit 80, “3” indicating that the width of the white streak image corresponds to three pixels is set.

In this case, the image signal temporary storage unit 81 reads the image signals in order of addresses (Y−2), (Y−1), (Y+3), (Y+4), . . . in such a manner that the image signals (i.e., image signals of the addresses=Y, Y+1, Y+2) for “3” pixels set in the streak width judgment unit 80 are not read from the address=Y set in the streak generation address control unit 79. Accordingly, the image signals from which the signals for three pixels in the addresses Y, Y+1, Y+2 have been removed are stored in the image signal temporary storage unit 81. As a result, as shown in FIG. 15, the image signals (white streak images) of the addresses Y, Y+1, Y+2 in the main scanning direction are removed in the whole read image.

According to the above-described streak removing process, since the streak images for a plurality of pixels are removed, image information for the plurality of pixels lacks in the whole read image. This means that the read image is deteriorated. However, when the above-described streak removing process is not performed, the streak image appears in the read image. That is, when the streak removing process is performed with respect to the streak image for the plurality of pixels, the image reading apparatus can provide an image without any sense of incongruity for the user without decreasing the productivity.

For example, as shown in FIG. 13 or 15, when the images for three pixels are removed, image information having a width of 42.3×3=126.9 μm is lost in the main scanning direction in the whole read image. However, the read image from which the streak images have been removed as shown in FIG. 13 or 15 has less sense of incongruity for the user than the read image still including the streak image as shown in FIG. 12 or 14. Therefore, especially, in images in which continuous gradation changes are not regarded as important, such as character and map images, the streak image is preferably removed by the streak removing process. This is because the image is obtained without any sense of incongruity in the character or map image, even when the image for several pixels lacks.

Moreover, the user may cancel the above-described streak removing process. The streak removing process can be cancelled, for example, by the following operation. That is, when the user instructs the canceling of the streak removing process in the control panel 46, the system control unit 45 outputs a cancel signal that is a control stop signal to the streak generation address control unit 79. The streak generation address control unit 79 which has received the cancel signal from the system control unit 45 does not perform address control for removing an image of a specific address. Accordingly, it is possible to cancel the streak removing process in accordance with user's intention.

Next, a second image correction process in the signal processing unit 64 will be described.

In the second image correction process, when the foreign matters exist on the document glass 11 and the white reference plate 23, the image signal (streak image) of the foreign matter is replaced with an image signal produced from an image signal in the vicinity. It is to be noted that the foreign matters on the document glass 11 or the white reference plate 23 appear as an image of a black streak (black streak image) or an image of a white streak (white streak image) in the read image of the document. In the present embodiment, the above-described second image correction process is referred to as a streak removing interpolation process.

A concrete operation example of the streak removing interpolation process will be described hereinafter.

First, the operation example of the streak removing interpolation process will be described with reference to the image including a black streak image having a width for one pixel.

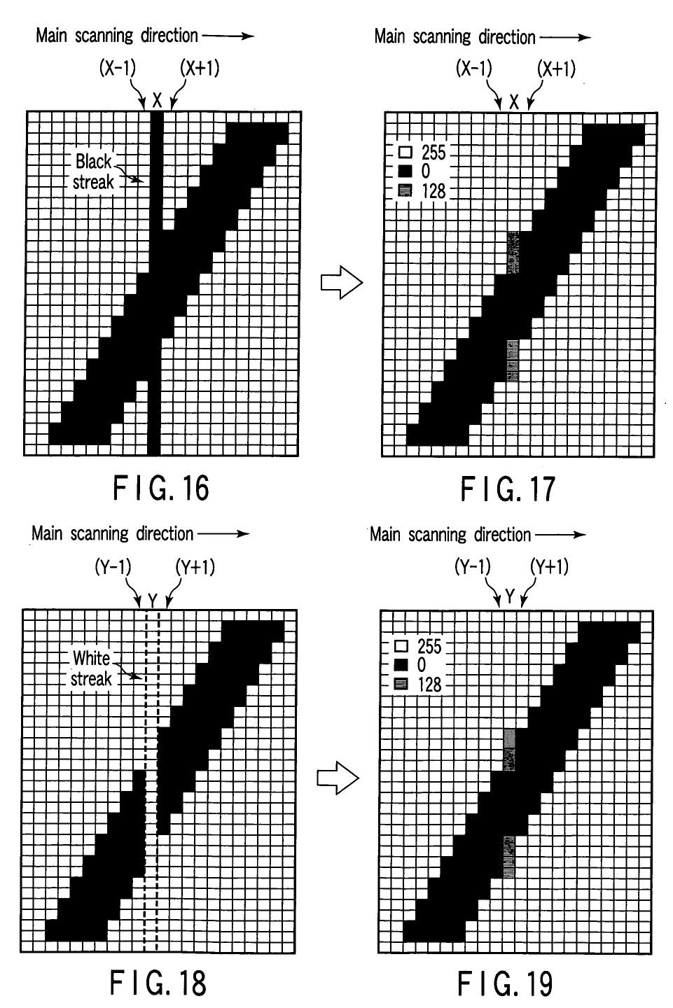

FIG. 16 shows an example of the read image in a case where the foreign matters stick to document glass 11 of the document reading position P1. FIG. 17 shows an example of an image obtained by subjecting the image of FIG. 16 to a streak removing interpolation process. In FIGS. 16 and 17, the lateral direction corresponds to the main scanning direction, and the longitudinal direction corresponds to the sub-scanning direction.

Here, it is assumed that the address of the black streak image in the main scanning direction is X in the image shown in FIG. 16. With respect to the image shown in FIG. 16, the document glass foreign matter detection unit 78b detects that the black streak image by the foreign matter sticking to the document glass 11 exists in the address X. That is, the document glass foreign matter detection unit 78b judges that the address of the black streak image is “X”, and the width of the black streak image is “1” (for one pixel). In this case, in the streak generation address control unit 79, the address=X is set as the generation address of the black streak image. In the streak width judgment unit 80, “1” indicating that the width of the black streak image corresponds to one pixel is set.

In this case, the image signal temporary storage unit 81 reads the image signal (i.e., image signal of the address X) for “1” pixel set in the streak width judgment unit 80 from the address=X set in the streak generation address control unit 79 in the image signal Dout normalized by the shading correction unit 77 with a predetermined value (e.g., “0”). That is, when the address=X is set in the streak generation address control unit 79, and “1” is set in the streak width judgment unit 80, the image signal temporary storage unit 81 reads the image signal having a predetermined value in the address X. Accordingly, the image signal having the predetermined value is stored in the address X in the image signal temporary storage unit 81.

It is to be noted that the image signal of the address X stored in the image signal temporary storage unit 81 may be an arbitrary image signal. For example, the image signal of the address X stored in the image signal temporary storage unit 81 may be “0”, or may remain as the image signal Dout. The image signal of the address X (value of the image signal) is replaced with the image signal (value of the image signal) produced by the correction signal generation unit 82 described later.

Moreover, when the address=X is set in the streak generation address control unit 79, and the “1” is set in the streak width judgment unit 80, the correction signal generation unit 82 produces the image signal (correction signal) of the address X by the image signal before/after the address X, that is, the image signals of the addresses (X−1) and (X+1). When producing the correction signal of the address X, the correction signal generation unit 82 replaces the image signal of the address X stored in the image signal temporary storage unit 81 with the correction signal to output the signal to the image processing unit 54 of the subsequent stage. As a result, the image signal (black streak image) of the address X in the main scanning direction of the read image is replaced with the correction signal produced from the value of the image signal in the vicinity of the address X.

Here, a production example of the correction signal by the correction signal generation unit 82 will be described.

The correction signal generation unit 82 produces the value of the correction signal of the pixel (image signal of the address X) forming the black streak image based on the pixel (image signals of the addresses (X−1) and (X+1)) before/after the black streak image (address X). In the present embodiment, the correction signal generation unit 82 produces the signal in such a manner that the value of the correction signal of the pixel (address X) forming the black streak image indicates an intermediate value (linearly changing value) between the values of the previous/subsequent pixels (addresses (X−1) and (X+1)).

The correction signal by the correction signal generation unit 82 is produced, for example, by the following equation.
Interpolation coefficient k=((value of image signal of address immediately before black streak image)−(value of image signal of address immediately after black streak image)/(value stored in streak width judgment unit)
Value of correction signal=(value of image signal of previous address)−k

According to these equations, the value of the correction signal of the address X shown in FIG. 16 is calculated by the following equation.
Interpolation coefficient k=((value of image signal of address (X−1))−(value of image signal of address (X+1))/(value “+1” stored in streak width judgment unit)
Value of correction signal of address X=(value of image signal of address (X−1))−k

For example, when the value of the image signal of the address (X−1) is “0”, and the value of the image signal of the address (X+1) is “0”, the value of the correction signal of the address X is “0” (k=(0−0)/2=0, the value of the correction signal=0−0=0) by the above equations.

Moreover, when the value of the image signal of the address (X−1) is “0”, and the value of the image signal of the address (X+1) is “255”, the value of the correction signal of the address X is “128” (k=(0−255)/2=−128, the value of the correction signal=0−(−128)=128) by the above equations.

Furthermore, when the value of the image signal of the address (X−1) is “255”, and the value of the image signal of the address (X+1) is “255”, the value of the correction signal of the address X is “255” (k=(255−255)/2=0, the value of the correction signal=255−0=255) by the above equations.

As a result, with regard to the read image shown in FIG. 16, as shown in FIG. 17, the image signal (black streak image) of the address X in the main scanning direction is replaced with the correction signal (intermediate value between the values of the image signals of the addresses (X−1) and (X+1)).

Next, an operation example of the streak removing interpolation process will be described with respect to the image including the white streak image having a width for one pixel.

FIG. 18 shows an example of the read image in a case where the foreign matters stick to the white reference plate 23. FIG. 19 shows an example of an image obtained by removing the white streak image from the image of FIG. 18. In FIGS. 18 and 19, the lateral direction corresponds to the main scanning direction, and the longitudinal direction corresponds to the sub-scanning direction. It is to be noted that the streak removing interpolation process with respect to the image including the white streak image is executed by a procedure similar to that of the streak removing interpolation process with respect to the image including the black streak image.

That is, when the white reference plate foreign matter detection unit 78a detects the white streak image having a width “1” in an address “Y” in the image shown in FIG. 18, the address=Y is set as the generation address of the white streak image in the streak generation address control unit 79, and “1” indicating that the width of the white streak image corresponds to one pixel is set in the streak width judgment unit 80.

In this case, the correction signal generation unit 82 produces image signal (correction signal) of the address Y by the pixel before/after the white streak image (address Y), that is, the image signals of the addresses (Y−1) and (Y+1). In the present embodiment, the correction signal generation unit 82 produces the signal in such a manner that the value of the correction signal of the pixel (address Y) forming the white streak image indicates an intermediate value (linearly changing value) between the values of the previous/subsequent pixels (addresses (Y−1) and (Y+1)).

The correction signal by the correction signal generation unit 82 is produced, for example, by the following equation.
Interpolation coefficient k=((value of image signal of address immediately before white streak image)—(value of image signal of address immediately after white streak image)/(value stored in streak width judgment unit)
Value of correction signal=(value of image signal of previous address)−k

According to these equations, the value of the correction signal of the address Y shown in FIG. 18 is calculated by the following equation.
Interpolation coefficient k=((value of image signal of address (Y−1))−(value of image signal of address (Y+1))/(value “+1” stored in streak width judgment unit)
Value of correction signal of address Y=(value of image signal of address (Y−1))−k

For example, when the value of the image signal of the address (Y−1) is “0”, and the value of the image signal of the address (Y+1) is “0”, the value of the correction signal of the address Y is “0”. When the value of the image signal of the address (Y−1) is “0”, and the value of the image signal of the address (Y+1) is “255”, the value of the correction signal of the address Y is “128”. When the value of the image signal of the address (Y−1) is “255”, and the value of the image signal of the address (Y+1) is “255”, the value of the correction signal of the address Y is “255”.

When producing the correction signal of the address Y, the correction signal generation unit 82 replaces the image signal of the address Y stored in the image signal temporary storage unit 81 with the correction signal to output the signal to the image processing unit 54 of the subsequent stage. As a result, the image signal (white streak image) of the address Y in the main scanning direction of the read image is replaced with the correction signal produced from the value of the image signal in the vicinity of the address Y. As a result, for example, the read image including the white streak image shown in FIG. 18 is corrected into the image shown in FIG. 19.

In the above-described streak removing interpolation process, the image signal of the pixel constituting the streak image is replaced with the correction signal produced from the image signal before/after the streak image. Therefore, the streak image is interpolated into an image holding concentration in a portion in which the concentrations of the previous/subsequent images are uniform, and interpolated into an image whose concentration change is smooth in a portion having the concentration change. That is, when the streak removing interpolation process is performed with respect to the streak images, the image reading apparatus can provide an image that is superior in reproducibility of the gradation change and that does not have any sense of incongruity without lowering the productivity.

For example, in the streak image shown in FIG. 16 or 18, as shown in FIGS. 17 and 19, a portion in which the pixels before/after the streak image have an equal concentration is interpolated by a pixel having a concentration equal to that of the pixel before/after the streak image, and a portion in which the pixels before/after the streak image have different concentrations is interpolated by the pixel having a concentration indicating an intermediate value with respect to the concentrations of the previous/subsequent pixels. Thus, the streak removing interpolation process is superior in reproducibility having a continuous gradation change as compared with the above-described streak removing process. Therefore, in the image in which the continuous gradation change is regarded as important as in a photograph image, an image which does not have any sense of incongruity can be provided, and therefore the streak image is preferably processed by the streak removing interpolation process.

Next, an operation example of the streak removing interpolation process with respect to the image including the black streak image having a width for a plurality of pixels will be described.

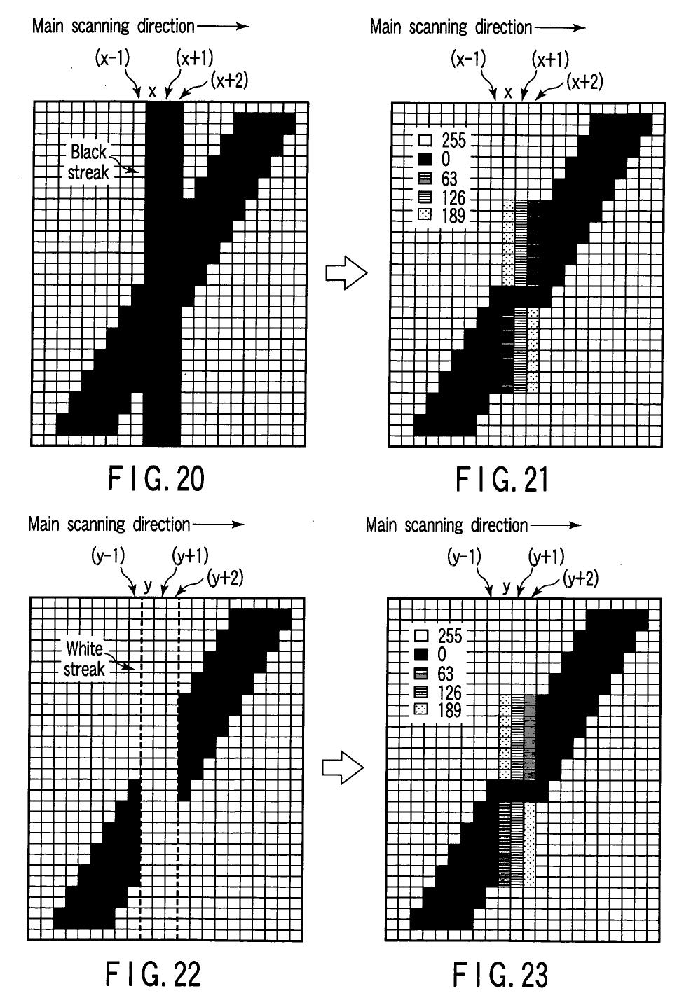

FIG. 20 shows an example of the read image in a case where the foreign matters stick to the document glass 11 of the document reading position P1. FIG. 21 shows an example of an image obtained by subjecting the image of FIG. 20 to the streak removing interpolation process. In FIGS. 20 and 21, the lateral direction corresponds to the main scanning direction, and the longitudinal direction corresponds to the sub-scanning direction.

Here, it is assumed that the addresses of the black streak images in the main scanning direction are X, (X+1), (X+2) in the image shown in FIG. 20. The document glass foreign matter detection unit 78b detects that the black streak images by the foreign matters sticking to the document glass 11 exist in the addresses X, (X+1), (X+2) with respect to the image shown in FIG. 20. That is, the document glass foreign matter detection unit 78b judges that the addresses of the black streak images are “X, (X+1), (X+2)”, and the width of the black streak image is “3” (for three pixels). In this case, the address=X is set as the generation address of the black streak image in the streak generation address control unit 79. In the streak width judgment unit 80, “3” indicating that the width of the black streak image corresponds to three pixels is set.

In this case, the image signal temporary storage unit 81 reads the image signals (i.e., the image signals of the addresses X, (X+1), (X+2)) for “3” pixels set in the streak width judgment unit 80 from the address=X set in the streak generation address control unit 79 in the image signal Dout normalized by the shading correction unit 77 with a predetermined value (e.g., “0”).

That is, when the address=X is set to the streak generation address control unit 79, and “3” is set in the streak width judgment unit 80, the image signal temporary storage unit 81 reads the image signal having the predetermined value in the addresses X, (X+1), (X+2). Accordingly, the image signal having the predetermined value is stored in the addresses X, (X+1), (X+2). It is to be noted that the image signal of the address X stored in the image signal temporary storage unit 81 may be an image signal having an arbitrary value.

Moreover, when the address=X is set to the streak generation address control unit 79, and “3” is set to the streak width judgment unit 80, the correction signal generation unit 82 produces the image signal (correction signal) of the address X, the image signal (correction signal) of the address (X+1), and the image signal (correction signal) of the address (X+2) by the image signals before/after the addresses X, (X+1), (X+2), that is, the image signals of the addresses (X−1) and (X+3).

When producing the correction signal of the address X, the correction signal generation unit 82 replaces the image signal of the address X stored in the image signal temporary storage unit 81 with the correction signal, and outputs the signal to the image processing unit 54 of the subsequent stage. Similarly, the correction signal generation unit 82 replaces the image signals of the addresses (X+1) and (X+2) stored in the image signal temporary storage unit 81 with the correction signals of the addresses (X+1) and (X+2), and outputs the signals to the image processing unit 54 of the subsequent stage. As a result, the image signals (black streak images) of the addresses X, (X+1), (X+2) in the main scanning direction of the read image are replaced with the correction signals produced from the values of the image signals in the vicinity of the addresses X, (X+1), (X+2).

Here, a production example of the correction signal by the correction signal generation unit 82 will be described.

In the present embodiment, the correction signal generation unit 82 produces the value of the correction signal of each pixel (addresses X, (X+1), (X+2)) forming the black streak image based on the previous/ subsequent pixels (values of the image signals of the addresses (X−1) and (X+3) in the main scanning direction with respect to the black streak image (addresses X, (X+1), (X+2)). Moreover, it is assumed that the correction signal generation unit 82 produces the signals in such a manner that the values of the correction signals of the addresses X, (X+1), (X+2) linearly change with respect to the values of the image signals of the addresses (X−1) and (X+3).

The correction signal by the correction signal generation unit 82 is produced, for example, by the following equations.
Interpolation coefficient k=((value of image signal of address immediately before black streak image)−(value of image signal of address immediately after black streak image)/(value stored in streak width judgment unit)
Value of correction signal=(value of image signal of previous address or value of correction signal of previous address)−k

According to these equations, the values of the correction signals of the addresses X, (X+1), (X+2) shown in FIG. 20 are calculated by the following equation.
Interpolation coefficient k=((value of image signal of address (X−1))−(value of image signal of address (X+3))/(value “+4” stored in streak width judgment unit)
Value of correction signal of address X=(value of image signal of address (X−1))−k
Value of correction signal of address (X+1)=(value of correction signal of address X)−k
Value of correction signal of address (X+2)=(value of correction signal of address (X+1))−k

That is, when the value of the image signal of the address (X−1) is “0”, and the value of the image signal of the address (X+3) is “0”, the values of the correction signals of the addresses X, (X+1), (X+2) are “0” (k=(0−0)/4=0, the value of the correction signal=0−0=0), respectively.

Moreover, when the value of the image signal of the address (X−1) is “0”, and the value of the image signal of the address (X+3) is “255”, the value of the correction signal of the address X is “63” (k=(0−255)/4=−63, the value of the correction signal=0−(−63)=63), the value of the correction signal of the address (X+1) is “126” (k=(0−255)/4=−63, the value of the correction signal=63−(−63)=126, and the value of the correction signal of the address (X+2) is “189” (k=(0−255)/4=−63, the value of the correction signal=126−(−63)=189) by the above equations.

Furthermore, when the value of the image signal of the address (X−1) is “255”, and the value of the image signal of the address (X+3) is “255”, the values of the correction signals of the addresses X, (X+1), (X+2) are “255” (k=(255−255)/4=0, the value of the correction signal=255−0=255), respectively, by the above equations.

As a result, with regard to the read image shown in FIG. 20, as shown in FIG. 21, the image signals (black streak images) of the addresses X, (X+1), (X+2) in the main scanning direction are replaced with the correction signals (correction values based on the values of the image signals of the addresses (X−1) and (X+3).

Next, an operation example of the streak removing interpolation process will be described with respect to the image including the white streak image having a width for a plurality of pixels.

FIG. 22 shows an example of a read image in a case where the foreign matters stick to the white reference plate 23. FIG. 23 shows an example of an image obtained by subjecting the image of FIG. 22 to the streak removing interpolation process. In FIGS. 22 and 23, the lateral direction corresponds to the main scanning direction, and the longitudinal direction corresponds to the sub-scanning direction.

Here, it is assumed that the addresses of the white streak images in the main scanning direction are Y, (Y+1), (Y+2) in the image shown in FIG. 22. The white reference plate foreign matter detection unit 78a detects that the white streak images by the foreign matters sticking to the white reference plate 23 exist in the addresses Y, (Y+1), (Y+2) with respect to the image shown in FIG. 22. That is, the white reference plate foreign matter detection unit 78a judges that the addresses of the white streak images are “Y, (Y+1), (Y+2)”, and the width of the white streak image is “3” (for three pixels). In this case, the address=Y is set as the generation address of the white streak image in the streak generation address control unit 79. In the streak width judgment unit 80, “3” indicating that the width of the white streak image corresponds to three pixels is set.

In this case, in the same manner as in the streak removing interpolation process with respect to the black streak image, the correction signal generation unit 82 produces the correction signal with respect to each pixel of the white streak image, and replaces the white streak image with the produced correction signal. That is, when the address=Y is set to the streak generation address control unit 79, and “3” is set to the streak width judgment unit 80, the correction signal generation unit 82 produces the image signal (correction signal) of the address Y, the image signal (correction signal) of the address (Y+1), and the image signal (correction signal) of the address (Y+2) by the image signals before/after the addresses Y, (Y+1), (Y+2), that is, the image signals of the addresses (Y−1) and (Y+3).

When producing the correction signals of the addresses Y, (Y+1), (Y+2), the correction signal generation unit 82 replaces the image signals of the addresses Y, (Y+1), (Y+2) stored in the image signal temporary storage unit 81 with the correction signals, and outputs the signals to the image processing unit 54 of the subsequent stage. As a result, the image signals (white streak images) of the addresses Y, (Y+1), (Y+2) in the main scanning direction of the read image are replaced with the correction signals produced from the values of the image signals in the vicinity of the addresses Y, (Y+1), (Y+2).

Here, in the present embodiment, the correction signal generation unit 82 produces the value of the correction signal of each pixel (addresses Y, (Y+1), (Y+2)) forming the white streak image based on the previous/subsequent pixels (values of the image signals of the addresses (Y−1) and (Y+3) in the main scanning direction with respect to the white streak image (addresses Y, (Y+1), (Y+2)). It is assumed that the correction signal generation unit 82 produces the signals in such a manner that the values of the correction signals of the addresses Y, (Y+1), (Y+2) linearly change with respect to the values of the image signals of the addresses (Y−1) and (Y+3).

The correction signal by the correction signal generation unit 82 is produced, for example, by the following equations.
Interpolation coefficient k=((value of image signal of address immediately before white streak image)−(value of image signal of address immediately after white streak image)/(value stored in streak width judgment unit)
Value of correction signal=(value of image signal of previous address or value of correction signal of previous address)−k

According to these equations, the values of the correction signals of the addresses Y, (Y+1), (Y+2) shown in FIG. 22 are calculated by the following equation.
Interpolation coefficient k=((value of image signal of address (Y−1))−(value of image signal of address (Y+3))/(value “+4” stored in streak width judgment unit)
Value of correction signal of address Y=(value of image signal of address (Y−1))−k
Value of correction signal of address (Y+1)=(value of correction signal of address Y)−k
Value of correction signal of address (Y+2)=(value of correction signal of address (Y+1))−k

That is, when the value of the image signal of the address (Y−1) is “0”, and the value of the image signal of the address (Y+3) is “0”, the values of the correction signals of the addresses Y, (Y+1), (Y+2) are “0”, respectively.

Moreover, when the value of the image signal of the address (Y−1) is “0”, and the value of the image signal of the address (Y+3) is “255”, the value of the correction signal of the address Y is “63”, the value of the correction signal of the address (Y+1) is “126”, and the value of the correction signal of the address (Y+2) is “189”.

Furthermore, when the value of the image signal of the address (Y−1) is “255”, and the value of the image signal of the address (Y+3) is “255”, the values of the correction signals of the addresses Y, (Y+1), (Y+2) are “255”, respectively.

As a result, with regard to the read image shown in FIG. 22, as shown in FIG. 23, the image signals (the respective pixels forming the white streak images) of the addresses Y, (Y+1), (Y+2) in the main scanning direction are replaced with the correction signals (correction values based on the values of the image signals of the addresses (Y−1) and (Y+3).

In the above-described streak removing interpolation process, the image signal of each pixel constituting the streak image is replaced with the correction signal produced from the image signal before/after the streak image. Therefore, the streak image in the whole read image is interpolated into an image holding its concentration in a portion in which the concentration is uniform, and interpolated into an image whose concentration change is smooth in a portion having the concentration change. That is, when the streak removing interpolation process is performed with respect to the streak images for a plurality of pixels, the image reading apparatus can provide an image that is superior in reproducibility of the gradation change and that does not have any sense of incongruity without lowering the productivity.

For example, in the streak image for three pixels shown in FIG. 20 or 22, as shown in FIGS. 21 and 23, a portion in which the pixels before/after the streak image have an equal concentration is interpolated by a pixel having a concentration equal to that of the pixel before/after the streak image, and a portion in which the pixels before/after the streak image have different concentrations is interpolated by the pixel whose concentration change is smooth with respect to the concentration of the previous/subsequent image. Thus, the streak removing interpolation process is superior in reproducibility having a continuous gradation change as compared with the above-described streak removing process. Therefore, especially in the image in which the continuous gradation change is regarded as important as in a photograph image, an image which does not have any sense of incongruity can be provided, and therefore the streak image is preferably processed by the streak removing interpolation process.

Moreover, the user may cancel the above-described streak removing interpolation process. The streak removing interpolation process can be cancelled, for example, by the following operation. That is, when the user instructs the canceling of the streak removing interpolation process in the control panel 46, the system control unit 45 outputs a cancel signal that is a control stop signal to the streak generation address control unit 79. The streak generation address control unit 79 which has received the cancel signal from the system control unit 45 does not perform address control for removing an image of a specific address. Accordingly, it is possible to cancel the streak removing interpolation process in accordance with user's intention.

Moreover, whether or not to execute the streak removing process or the streak removing interpolation process may be set in accordance with the width (streak width) of the streak image.

That is, an upper limit of the width of the streak image with which the streak removing process is executed is set beforehand. Then, when the width of the streak image is not less than the upper limit value (predetermined amount), the streak removing process or the streak removing interpolation process may be canceled. This can be realized by outputting the cancel signal that is the control stop signal to the streak generation address control unit 79 from the system control unit 45, when a value larger than the upper limit value is set to the streak width judgment unit 80.

Furthermore, when the streak image having a width not less than the upper limit value is detected, the system control unit 45 cancels the streak removing process or the streak removing interpolation process, and may display a warning indicating that the foreign matters stick to the white reference plate 23 or the document glass 11 in the control panel 46.

Next, a case will be described where the streak removing process and the streak removing interpolation process are selectively executed.

As described above, in the streak removing process, the streak image is completely removed from the read image which is a reading result of the document image. Therefore, the streak removing process is preferably applied to the reading of an image (hereinafter referred to as the character image) in which the continuous gradation change is not regarded as important as in the characters or maps. On the other hand, in the streak removing interpolation process, the streak image is replaced with an image which smoothly changes (linearly changes) with respect to the images before/after the streak image. Therefore, the streak removing interpolation process is preferably applied especially to the reading of the image (hereinafter referred to as the photograph image) in which the continuous gradation change is regarded as important as in a photograph.

Therefore, the image reading apparatus is capable of selecting the streak removing process or the streak removing interpolation process in accordance with the type of the document image which is a reading object, and appropriately correcting the streak image in accordance with the type of the document image.

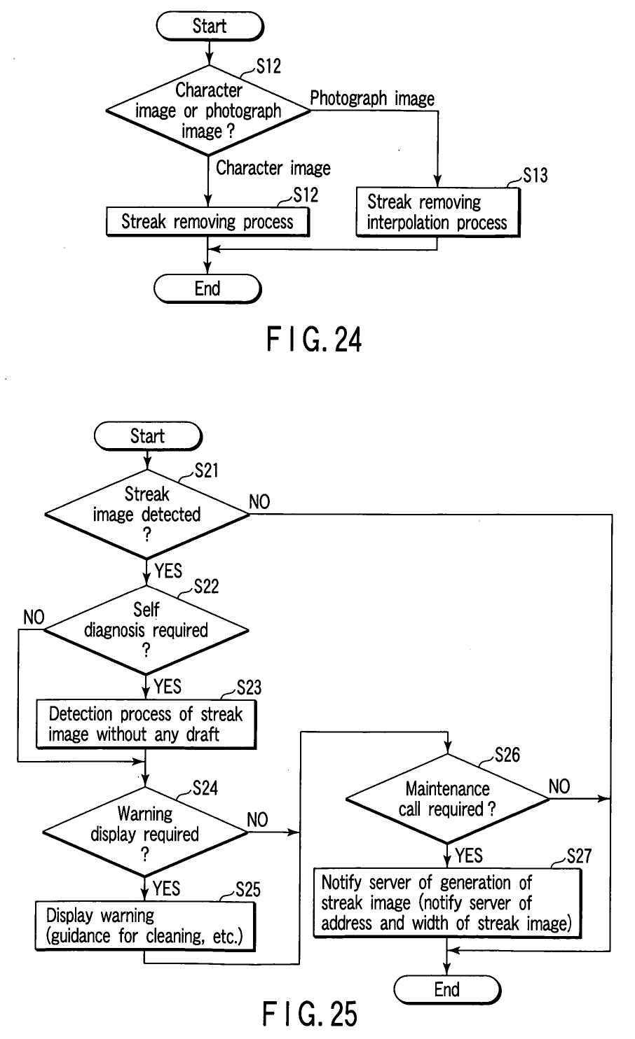

FIG. 24 is a flowchart showing an operation example in a case where the streak removing process or the streak removing interpolation process is executed in accordance with the type of the document image.

Here, in the description, it is assumed that the user designates the type of the document image using the control panel 46. The type of the document image is set beforehand in the character image in the setting of default, and the setting may be changed to the photograph image only in a case where the user instructs the reading of the photograph image by the control panel 46.

For example, it is assumed that the user designates the character image as the type of the document image in the control panel 46 to instruct image reading start. When the character image is designated as the type of the document image by the user via the control panel 46, and the image reading start is instructed, the CPU 51 of the system control unit 45 judges the reading start of the document image in a reading mode of the character image (step S11, character image).

When judging that the reading of the document image be started in a reading mode of the character image, the CPU 51 of the system control unit 45 instructs the start of the reading of the document image with respect to the image reading unit 1a, and notifies the unit that the reading mode of the document image is set to the character image. The CPU 51 of the image reading unit 1a which has been notified sets the reading mode of the document image to the character image, and starts reading the document image. In the process to set the reading mode of the document image to the character image, the CPU 51 selects the streak removing process as a correction process (image correction process) with respect to the streak image in the character image with respect to the signal processing unit 64, and performs the setting in such a manner as to execute the streak removing process with respect to the image signal of the document image (step S12).

In this case, the signal processing unit 64 executes the above-described streak removing process. That is, in the signal processing unit 64, the image signal forming the streak image is prevented from being read into the image signal temporary storage unit 81 based on the generation address of the streak image set to the streak generation address control unit 79 and the streak width set to the streak width judgment unit 80. Furthermore, the image signal stored in the image signal temporary storage unit 81 is output to the image processing unit 54 of the subsequent stage through the correction signal generation unit 82.

Moreover, it is assumed that the user designates the photograph image as the type of the document image in the control panel 46 to instruct the image reading start. When the user designates the photograph image as the type of the document image via the control panel 46, and instructs the image reading start, the CPU 51 of the system control unit 45 judges the reading start of the document image in the reading mode of the photograph image (step S12, photograph image).

When judging that the reading of the document image be started in the reading mode of the photograph image, the CPU 51 of the system control unit 45 instructs the start of the reading of the document image with respect to the image reading unit 1a, and notifies the unit that the reading mode of the document image is set to the photograph image. The CPU 51 of the image reading unit 1a which has been notified sets the reading mode of the document image to the photograph image, and starts reading the document image. In the process to set the reading mode of the document image to the photograph image, the CPU 51 selects the streak removing interpolation process as the correction process (image correction process) with respect to the streak image in the photograph image with respect to the signal processing unit 64, and performs the setting in such a manner as to execute the streak removing interpolation process with respect to the image signal of the document image (step S13).

In this case, the signal processing unit 64 executes the above-described streak removing interpolation process. That is, in the signal processing unit 64, the image signal forming the streak image is replaced with the correction signal produced from the image signals before/after the streak image based on the generation address of the streak image set to the streak generation address control unit 79 and the streak width set to the streak width judgment unit 80, and output to the image processing unit 54 of the subsequent stage by the correction signal generation unit 82.

It is to be noted that the type of the document image may be judged from a concentration distribution or the like in the document image. For example, in the character image, the concentration distribution is bipolarized (concentrations of a character portion and a base). The concentration distribution is uniform in the photograph image. Therefore, when the concentration distribution in the document image is analyzed, it is possible to distinguish the type of the document image.

Moreover, the user may designate the streak removing process or the streak removing interpolation process as the correction process with respect to the streak image by the control panel 46. Accordingly, the correction process (image correction process) may be performed with respect to the streak image in accordance with the user's intention.

For example, it is assumed that the user designates the streak removing process as the correction process (image correction process) with respect to the streak image by the control panel 46, and instructs the image reading start. In this case, the CPU 51 of the system control unit 45 instructs the image reading unit 1a to start the reading of the document image, and notifies the unit that the correction process with respect to the streak image be set to the streak removing process. The CPU 51 of the image reading unit 1a which has received this notice sets the image correction process of the signal processing unit 64 to the streak removing process, and starts the reading operation of the document image. Accordingly, the signal processing unit 64 executes the above-described streak removing process.

Moreover, it is assumed that the user designates the streak removing interpolation process as the correction process (image correction process) with respect to the streak image by the control panel 46, and instructs the image reading start. In this case, the CPU 51 of the system control unit 45 instructs the image reading unit 1a to start the reading of the document image, and notifies the unit that the correction process with respect to the streak image be set to the streak removing interpolation process. The CPU 51 of the image reading unit 1a which has received this notice sets the image correction process of the signal processing unit 64 to the streak removing interpolation process, and starts the reading operation of the document image. Accordingly, the signal processing unit 64 executes the above-described streak removing interpolation process.

Next, an operation example will be described in a case where the streak image (foreign matters on the white reference plate 23 or the document glass 11) is detected.

Here, an operation example in which a warning indicating that the foreign matters stick to the white reference plate 23 or the document glass 11 is displayed in the control panel 46, and an operation example in which the internet server 43 is notified that the foreign matters stick to the white reference plate 23 or the document glass 11 will be described.

FIG. 25 is a flowchart showing an operation example in a case where the foreign matter detection unit 78 detects the streak image at the time of the reading of the document image.

Every time the image reading unit 1a executes the reading operation of the image, the CPU 51 of the system control unit 45 judges whether or not the streak image has been detected based on the output from the streak width judgment unit 80 (step S21). For example, when the streak image is detected by the foreign matter detection unit 78, that is, when it is detected by the streak image that the foreign matters stick to the white reference plate 23 or the document glass 11, a value indicating the width of the streak image is set to the streak width judgment unit 80. When the value indicating the value of the streak image is set to the streak width judgment unit 80, the CPU 51 of the system control unit 45 that the streak image has been detected.

When it is judged by the above-described judgment that the foreign matter detection unit 78 has detected the streak image (step S21, YES), the CPU 51 of the system control unit 45 judges whether or not a process of detecting the streak image needs to be executed as self diagnosis without any document (step S22). In the self diagnosis, the detection process (foreign matter detection process) of the streak image is performed without any document, and accordingly the streak image (foreign matters sticking to the white reference plate 23 or the document glass 11) is correctly detected.

Here, the self diagnosis is set beforehand in such a manner as to be executed in a case where the streak image having a width which is not less than a predetermined amount (first threshold value) is detected. In this case, the first threshold value for judging whether or not to execute the self diagnosis is set beforehand by the user or the serviceman. It is to be noted that when the first threshold value is set to a large value, it is possible to perform such setting to cancel the self diagnosis.

When it is judged by the above-described judgment that the self diagnosis needs to be executed (step S22, YES), the CPU 51 of the system control unit 45 instructs the CPU 61 of the image reading unit 1a to perform the detection process of the streak image without any document. The CPU 61 of the image reading unit 1a which has received this instruction performs the reading operation without any document, and accordingly executes the detection process (foreign matter detection process) of the streak image by the foreign matter detection unit 78. In this case, in the streak width judgment unit 80, the width of the streak image detected without any document is set (step S23).

Moreover, after executing the self diagnosis (step S22) or judging that the self diagnosis does not have to be executed by the above-described judgment (step S22, NO), the CPU 51 of the system control unit 45 judges whether or not the warning needs to be displayed in the control panel 46 (step S24). In this warning display, it is notified to the user that the foreign matters causing the streak image stick to the white reference plate 23 or the document glass 11.

Moreover, the warning is set beforehand in such a manner that the warning is performed in a case where the streak image having a width which is not less than a predetermined amount (second threshold value) is detected. In this case, the second threshold value for judging whether or not to display the warning is set beforehand by the user or the serviceman. It is to be noted that when the second threshold value is set to a large value, it is possible to perform such setting to prevent the warning from being displayed.

When it is judged by the above-described judgment that the warning needs to be displayed (step S24, YES), the CPU 51 of the system control unit 45 displays the warning indicating that the foreign matters stick to the white reference plate 23 or the document glass 11 in the control panel 46 (step S25).

It is to be noted that as to contents of the warning displayed in the control panel 46, for example, it is notified that the white reference plate 23 or the document glass 11 be cleaned. When the white streak image is detected by the white reference plate foreign matter detection unit 78a, it is notified that the foreign matters stick to the white reference plate 23. When the black streak image is detected by the document glass foreign matter detection unit 78b, it may be notified that the foreign matters stick to the document glass 11.

Moreover, when the above-described warning is displayed (step S25), or when it is judged in the above-described judgment that the warning does not have to be displayed (step S24, NO), the CPU 51 of the system control unit 45 judges whether or not a maintenance call is required (step S26). The maintenance call notifies the internet server 43 that a disadvantage has been generated in the digital copying machine 41.

Here, as the maintenance call, the CPU 51 of the system control unit 45 notifies the internet server 43 that the streak image is generated by the foreign matters sticking to the white reference plate 23 or the document glass 11. The CPU 51 of the system control unit 45 notifies the internet server 43 of the generation address of the streak image set to the streak generation address control unit 79 and the data indicating the width of the streak image set to the streak width judgment unit 80 as the maintenance call (step S27). On the other hand, in the internet server 43, the data (the generation address of the streak image, the value indicating the width of the streak image, etc.) notified from the digital copying machine 41 is stored in a storage device.

By the above-described maintenance call, a serviceman in charge of the maintenance of the digital copying machine 41 can know the state of the digital copying machine 41 (image reading apparatus) by the data notified by the internet server 43. As a result, the serviceman can easily know a maintenance time in accordance with situations of the digital copying machine, and perform a countermeasure such as cleaning.

It is to be noted that, in the present embodiment, various processes in the image reading apparatus which reads a monochromatic image have been described, and these processes are also applicable to an image reading apparatus which reads a color image. For example, in an image reading apparatus to read an image by a CCD sensor in which a red, green, or blue filter is disposed on a light receiving surface, processes similar to the above-described processes can be applied with respect to image signals of colors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image reading apparatus which converts a document image into image data, comprising:
a photoelectric conversion unit which sequentially converts an image of a document scanned in a sub-scanning direction into an image signal constituted of a plurality of pixels constituting one line in a main scanning direction;
a detection unit which detects presence of a streak image of the sub-scanning direction with respect to the image signal of the document image photoelectrically converted by the photoelectric conversion unit; and
an image correction unit which corrects the image signal of the pixel forming the streak image detected by the detection unit among the image signals of the document image photoelectrically converted by the photoelectric conversion unit in a case where the detection unit detects that the streak image has been generated.

2. The image reading apparatus according to claim 1, wherein the image correction unit removes the pixel forming the streak image detected by the detection unit from the image signal of the document image photoelectrically converted by the photoelectric conversion unit.

3. The image reading apparatus according to claim 1, further comprising:
a streak generation address control unit which indicates a position of the streak image detected by the detection unit in the main scanning direction; and
a streak width judgment unit which indicates a width of the streak image detected by the detection unit in the main scanning direction,
wherein the image correction unit removes the pixel forming the streak image from the image signal of the document image photoelectrically converted by the photoelectric conversion unit based on the position of the streak image in the main scanning direction indicated by the streak generation address control unit, and the width of the streak image in the main scanning direction indicated by the streak width judgment unit.

4. The image reading apparatus according to claim 1, wherein the image correction unit replaces the pixel forming the streak image detected by the detection unit in the image signal of the document image photoelectrically converted by the photoelectric conversion unit with a pixel which linearly changes with respect to pixels before/after the streak image in the main scanning direction.

5. The image reading apparatus according to claim 1, wherein the image correction unit replaces the pixel forming the streak image detected by the detection unit in the image signal of the document image photoelectrically converted by the photoelectric conversion unit with the pixel having an intermediate value with respect to the values of the pixels before/after the streak image in the main scanning direction in a case where the width of the streak image in the main scanning direction detected by the detection unit corresponds to one pixel.

6. The image reading apparatus according to claim 1, wherein the image correction unit replaces each pixel forming the streak image detected by the detection unit in the image signal of the document image photoelectrically converted by the photoelectric conversion unit with the pixel having a value linearly changing with reference to pixels before/after the streak image in the main scanning direction in a case where the width of the streak image in the main scanning direction detected by the detection unit corresponds to a plurality of pixels.

7. The image reading apparatus according to claim 1, further comprising:
a streak generation address control unit which indicates a position of the streak image detected by the detection unit in the main scanning direction; and
a streak width judgment unit which indicates a width of the streak image detected by the detection unit in the main scanning direction,
wherein the image correction unit replaces the pixel forming the streak image detected by the detection unit in the image signal of the document image photoelectrically converted by the photoelectric conversion unit with a pixel which linearly changes with respect to pixels before/after the streak image in the main scanning direction based on the position of the streak image in the main scanning direction indicated by the streak generation address control unit and the width of the streak image in the main scanning direction indicated by the streak width judgment unit.

8. The image reading apparatus according to claim 1, further comprising:
an operation unit for a user to select whether or not to correct the streak image by the image correction unit,
wherein the image correction unit prohibits correction with respect to the streak image in a case where canceling of the correction with respect to the streak image is selected by the operation unit, and executes the correction with respect to the streak image in a case where execution of the correction with respect to the streak image is selected by the operation unit.

9. An image reading apparatus which converts a document image into image data, comprising:
a photoelectric conversion unit which sequentially converts an image of a document scanned in a sub-scanning direction into an image signal constituted of a plurality of pixels constituting one line in a main scanning direction;
a detection unit which detects presence of a streak image of the sub-scanning direction with respect to the image signal of the document image photoelectrically converted by the photoelectric conversion unit; and
an image correction unit which selectively executes a streak removing process to remove the pixels forming the streak image or a streak removing interpolation process to replace each pixel forming the streak image with a pixel linearly changing with respect to pixels before/after the streak image in a case where the detection unit detects that the streak image has been generated.

10. The image reading apparatus according to claim 9, wherein the image correction unit executes the streak removing process as correction with respect to the streak image in case of a document image in which a continuous gradation change is not regarded as important, and executes the streak removing interpolation process as the correction with respect to the streak image in case of a document image in which the continuous gradation change is regarded as important.

11. The image reading apparatus according to claim 9, wherein the image correction unit executes the streak removing process as correction with respect to the streak image in case of a document image of such a type that a continuous gradation change is not regarded as important, and executes the streak removing interpolation process as the correction with respect to the streak image in case of a document image of such a type that the continuous gradation change is regarded as important.

12. The image reading apparatus according to claim 11, wherein a type of the document image in which the continuous gradation change is not regarded as important is a character image.

13. The image reading apparatus according to claim 11, wherein a type of the document image in which the continuous gradation change is regarded as important is a photograph image.

14. The image reading apparatus according to claim 9, further comprising:
an operation unit for a user to designate whether to perform the streak removing process or the streak removing interpolation process as the correction with respect to the streak image by the image correction unit,
wherein the image correction unit executes the streak removing process as the correction with respect to the streak image in a case where the streak removing process is designated as the correction with respect to the streak image by the operation unit, and executes the streak removing interpolation process as the correction with respect to the streak image in a case where the streak removing interpolation process is designated as the correction with respect to the streak image by the operation unit.

15. The image reading apparatus according to claim 9, further comprising:
an operation unit for a user to designate a type of the document image,
wherein the image correction unit executes the streak removing process as the correction with respect to the streak image in a case where the type of the document image designated by the operation unit is such that a continuous gradation change is not regarded as important, and executes the streak removing interpolation process as the correction with respect to the streak image in a case where the type of the document image designated by the operation unit is such that the continuous gradation change is regarded as important.

16. An image reading apparatus which has a function of communicating with an external apparatus, comprising:
a photoelectric conversion unit which sequentially converts an image of a document scanned in a sub-scanning direction into an image signal constituted of a plurality of pixels constituting one line in a main scanning direction;
a detection unit which detects presence of a streak image of the sub-scanning direction with respect to the image signal of the document image photoelectrically converted by the photoelectric conversion unit; and
a communication interface which notifies the external apparatus of generation of the streak image in a case where the detection unit detects that the streak image has been generated.

17. The image reading apparatus according to claim 16, further comprising:
a document feeding device which conveys a document,
wherein the photoelectric conversion unit sequentially converts an image for one line in the main scanning direction into an image signal in a predetermined document reading position with respect to the document conveyed by the document feeding device to thereby convert the whole document image into an image signal,
the detection unit detects presence of the streak image in the sub-scanning direction in the image signal of the document image photoelectrically converted by the photoelectric conversion unit, and
the communication interface notifies the external apparatus that foreign matters causing the streak image stick to the document reading position in a case where the detection unit detects the generation of the streak image.

18. The image reading apparatus according to claim 16, further comprising:
a white reference plate which is a white reference of the image signal; and
a shading correction unit which uses the image signal obtained by photoelectrically converting a white reference of the white reference plate by the photoelectric conversion unit as a white reference signal and which corrects the image signal of the document image photoelectrically converted by the photoelectric conversion unit based on the white reference signal,
wherein the detection unit detects presence of the streak image in the sub-scanning direction in the image signal of the document image photoelectrically converted by the photoelectric conversion unit, and
the communication interface notifies the external apparatus that foreign matters causing the streak image stick to the white reference plate in a case where the detection unit detects the generation of the streak image.

19. The image reading apparatus according to claim 16, further comprising:
a streak width judgment unit which indicates a width of the streak image in the main scanning direction detected by the detection unit; and
a judgment unit which judges whether or not the width of the streak image is not less than a predetermined amount based on the width of the streak image in the main scanning direction indicated by the streak width judgment unit,
wherein the communication interface notifies the external apparatus that the streak image has been generated in a case where the judgment unit judges that the width of the streak image is not less than the predetermined amount.

20. The image reading apparatus according to claim 16, further comprising:
a streak generation address control unit which indicates a position of the streak image in the main scanning direction detected by the detection unit; and
a streak width judgment unit which indicates a width of the streak image in the main scanning direction detected by the detection unit,
wherein the communication interface notifies the external apparatus of the position of the streak image in the main scanning direction indicated by the streak generation address control unit and the width of the streak image in the main scanning direction indicated by the streak width judgment unit.
